(19) United States
(12) Patent Application Publication
(10) Pub. No.: US 2025/0196077 A1
(43) Pub. Date: Jun. 19, 2025

(54) SCREW ELEMENTS WITH IMPROVED MIXING EFFECT AND PRESSURE BUILD-UP

(71) Applicant: Covestro Deutschland AG, Leverkusen (DE)

(72) Inventors: Thomas Koenig, Leverkusen (DE); Michael Bierdel, Leverkusen (DE); Ulrich Liesenfelder, Bergisch Gladbach (DE)

(21) Appl. No.: 18/845,689

(22) PCT Filed: Mar. 1, 2023
(86) PCT No.: PCT/EP2023/055123

§ 371 Date: Sep. 10, 2024

(30) Foreign Application Priority Data
Mar. 11, 2022 (EP) 22161631.1

(51) Int. Cl. B01F 27/1143; B01F 27/723; B01F 101/00; B29C 48/40; B29C 48/535; B29C 48/635

(52) U.S. Cl. CPC B01F 27/1143; B01F 27/723; B29C 48/402; B29C 48/535; B29C 48/635; B01F 2101/2805; B01F 2215/0422; B01F 2215/0431

(57) ABSTRACT

The invention relates to a four-flight screw element for a multishaft screw machine with screw shafts rotating in the same direction and at the same speed. The two screw elements according to the invention, which are located opposite each other directly adjacent on two directly adjacent screw shafts, practically clean each other in pairs. The invention also relates to the use of the screw element according to the invention in a multishaft screw machine and to a multishaft screw machine which is equipped with a pair of screw elements according to the invention, as well as to a method for the extrusion of plastic or viscoelastic masses using the screw element according to the invention.

### CROSS REFERENCE TO RELATED APPLICATIONS

This application is a U.S. national stage application, filed under 35 U.S.C. § 371, of International Application No. PCT/EP2023/055123, which was filed on Mar. 1, 2023, and which claims priority to European Patent Application No. 22161631.1, which was filed on Mar. 11, 2022. The entire contents of each are hereby incorporated by reference into this specification.

### FIELD

The invention relates to a pair of four-flight screw elements for a multishaft screw machine with screw shafts rotating in the same direction and at the same speed. The two screw elements of the pair of screw elements according to the invention, which are located directly adjacent on two directly adjacent screw shafts opposite each other, practically clean each other. The invention also relates to the use of the pair of screw elements according to the invention in a multishaft screw machine and to a multishaft screw machine which is equipped with a pair of screw elements according to the invention, as well as to a method for the extrusion of plastic or viscoelastic masses using the pair of screw elements according to the invention.

In the context of the present invention, a multishaft screw machine is understood to mean a screw machine having more than one screw shaft, for example a screw machine having two, three or four screw shafts or else a screw machine having eight to sixteen, especially twelve, screw shafts in an annular arrangement. In the case of more than two screw shafts, the axes of rotation of the screw shafts may be arranged next to one another, or else, for example—as in the case of what is called a ring extruder—in annular form. In multishaft extruders, the axes of rotation of the screw shafts are generally arranged parallel to each other. This parallel arrangement of the axes of rotation is also favoured according to the invention. The screw elements according to the invention are preferably in a number that corresponds to the number of screw shafts of the respective extruder on which screw shafts are arranged opposite. Such a screw machine having more than one screw shaft is also referred to hereinafter as a multiple-shaft screw machine, multishaft screw machine or multishaft extruder. A twin-shaft screw machine is also referred to hereinafter as a twin-screw extruder. In the context of the present invention, the term “screw machine” is used synonymously with the term “extruder”.

### BACKGROUND

Modern extruders have a modular system in which various screw elements can be mounted on a core shaft to form a screw shaft; such a screw shaft is therefore segmented. This allows a person skilled in the art to adapt the extruder to the respective process task. However, a screw shaft can also be made in one piece, i.e. can have only one screw element that extends substantially over the entire length of the screw shaft, or can be only partially segmented. The present invention relates both to screw elements that can be mounted on a core shaft and to the screw shafts made from a single piece described above.

Co-rotating twin-screw machines of which the screw shafts clean each other precisely have been known for a long time, e.g. from DE 862 668 C. In polymer production and processing, screw machines with screw shafts of which the screw elements are based on the principle of precisely cleaning screw cross-sectional profiles have been used in a variety of ways. This is mainly due to the fact that polymer melts adhere to surfaces and degrade over time at normal processing temperatures, which is prevented by the self-cleaning effect of screw elements in multishaft machines that precisely clean each other in pairs. Rules for generating cross-sectional screw profiles for screw elements which clean each other exactly are shown, for example, in [1] ([1]=Klemens Kohlgrüber: “Der gleichläufige Doppelschneckenextruder” [Codirectional Twin-Screw Extruders], 2nd Edition, Hanser Verlag München 2016, pages 107 to 120). According to the description there, in the case of screw elements which clean each other exactly, a predetermined cross-sectional screw profile on the first shaft of a twin-screw extruder determines the cross-sectional screw profile on the second shaft of the twin-screw extruder ([1], page 108). A screw cross-sectional profile, also referred to as a screw profile for short in the context of the present invention, is understood to mean the outer contour of a screw element in a plane section at right angles to the axis of rotation of the screw element, in accordance with the axis of rotation of the associated screw shaft. The screw profile for the screw element on the first shaft is referred to as the generating screw profile. The screw profile for the screw element on the second shaft follows from the screw profile of the first shaft of the twin-screw extruder and is therefore referred to as the generated screw profile. In a multishaft extruder, the screw element with the generating screw profile and the screw element with the generated screw profile are always used alternately on neighboring shafts.

Two things need to be distinguished here: The precisely scraping screw profile, a mathematical construct in which two screw elements, which lie opposite each other on two immediately neighboring screw shafts, clean each other without any gap, and screw profiles for screw elements designed in material reality for the intended use, i.e. technically executed screw elements. If the term “precisely cleaning” is used in the context of the present invention, this means—unless otherwise stated—the mathematical construct of a precisely cleaning screw profile or the corresponding screw element having this screw profile. If the term “practically cleaning” is used in the context of the present invention, this means—unless otherwise explained—the technically executed screw element or its screw profile, wherein this practically cleaning screw profile has been derived from a precisely cleaning screw profile, preferably by applying one of the clearance strategies: center distance increase, longitudinal section equidistant, circular equidistant or spatial equidistant, particularly preferably by applying one of the clearance strategies: longitudinal section equidistant, circular equidistant or spatial equidistant, as explained in more detail below.

The strategies of longitudinal section equidistant, circular equidistant and spatial equidistant are also referred to below as the longitudinal section equidistant calculation rule, circular equidistant calculation rule and spatial equidistant calculation rule.

A person skilled in the art of screw elements will of course understand that a single screw element or screw profile on its own cannot be precisely scraping or practically scraping, but that a pair of such elements is always required.

A person skilled in the art knows, specifically, that, in the case of industrially implemented machines, it is necessary to deviate from the precisely cleaning geometry to the extent that constant clearances must be maintained during the mutual cleaning of the screw elements. This is necessary in order to prevent adhesive and thus premature wear, in order to compensate for manufacturing tolerances or to avoid excessive energy dissipation in the clearances.

For example, [1], pages 40 and 41 and 117 to 121, discloses methods for constructing screw elements that maintain a constant clearance during mutual cleaning. There, for example, a calculation rule is given on how to construct a screw profile from a precisely cleaning screw profile in which there is a constant clearance between the mutually cleaning pairs of screw elements in the longitudinal section of the screw machine, i.e. a longitudinal section equidistant calculation rule. In the following, precisely cleaning screw profiles are described, from which a person skilled in the art can derive the screw profile of the screw elements to be manufactured using the known calculation rules.

For the purposes of the present invention, a clearance is understood to be the distance between the closest points of the screw profiles of two screw elements that practically clean each other.

Various strategies are possible for generating constant clearances. The most common is the generation of clearances that are equidistant in a longitudinal section through the machine. The procedure for generating the corresponding screw profiles has been presented as already mentioned in [1] on pages 40 and 41 and also 117 to 121.

The rules for generating screw profiles with constant clearances are applicable to the screw elements according to the invention.

Screw elements that aim to improve the mixing effect have also been the subject of technical development for a long time. Numerous known geometries neglect the fact that screw elements should advantageously clean each other precisely, such as all variants of toothed mixing elements, for example DE 4 134 026 A1, DE 19 706 134 A1 or WO 2004 009 326 A1. This class of mixing elements is fundamentally characterized in that a screw thread is equipped with openings or grooves that interrupt the material transport and ensure improved mixing. However, the surfaces in the openings or grooves are not cleaned kinematically, so that material can adhere at these points, degrade and become a source of contamination for the extrudate—in this case the plastic or viscoelastic mass to be extruded.

However, mixing elements with complete self-cleaning have also been known for a long time. For example, DE 940 109 C already disclosed three-flight kneading disks that provided an improved mixing effect compared to continuously running screw flights.

DE 3 412 258 A1 teaches how gaps between the screw crests and the housing inner wall can be designed for three- and four-flight screw elements for twin-screw extruders. The extrudate is sheared in a targeted manner by a different gap at the screw crests. For this purpose, a symmetrical arrangement of three- or four-flight screw profiles of a twin screw, which a priori have the same gap S (there called & (pronounced “delta”)) to the housing at all screw crests, is displaced parallel from the centers of rotation with an eccentricity e that is smaller than the gap S.

EP 2 131 A1 discloses a method for producing self-cleaning screw elements in pairs, wherein the individual screw crests of these screw elements have a different gap to the housing. The gap width of an individual screw crest can be increased here up to half the flight depth h. The aim here is also to create a material exchange between the individual screw flights and to shear the material in a targeted manner as it passes over the screw crest. The resulting two-flight screw elements have no axes of symmetry and different crest angles at the two screw crests. Three- and four-flight screw elements are also claimed. With three-flight screw elements, the gap is enlarged at either one or two of the three screw crests. The flight depth h is understood here to be half the distance which is the difference between the outer diameter da of the screw element and the core diameter di of the screw element, i.e. h=(da−di)/2.

DE 42 39 220 A1 describes three-flight screw elements that have different gaps and different crest angles at the three crests, wherein the screw crest with the smallest gap to the housing has the largest crest angle. This allows the construction of three-flight screw profiles with a ratio of outer diameter da to core diameter di of greater than 1.366. However, the screw elements designed according to this construction principle are disadvantageous because the screw crest with the narrowest gap and at the same time the largest crest angle has a zone of high shear stress for the polymer to be processed, in which damage may easily occur due to the high shear and temperature stress.

WO 02 09 919 A2 describes, among other things, three-flight and four-flight screw elements, wherein the crest angles at each screw crest of a three- or four-flight screw element can be designed differently.

However, WO 02 09 919 A2 does not teach which embodiments are favorable with regard to their mixing and dispersing effect or their behavior during pressure build-up.

EP 1 093 905 A2 describes screw profiles for three-flight, self-cleaning screw element pairs for twin-screw extruders with a high distributive and dispersive mixing effect. However, the screw elements described there have the disadvantage that they have a wide crest angle at the point with the narrowest gap to the housing wall, which results in a zone with high energy dissipation and a high local temperature peak, which can lead to damage in the case of sensitive polymers.

Conventional, i.e., double axisymmetric four-flight screw profiles can be designed down to a minimum ratio of center distance a to housing inner diameter dg of 0.924 ([1], page 116, table 2.2 and FIG. 2.10) in order to obtain screw elements that clean each other precisely and that can be used in a multi-screw machine with screw shafts rotating in the same direction and at the same speed with such a ratio of center distance a to housing inner diameter dg. However, machines with a ratio of center distance a to housing inner diameter dg of greater than 0.924 are not commonly used, which is why four-flight screw elements are not used in self-cleaning multishaft extruders.

Two four-flight screw elements, which are directly adjacent to each other in pairs on two of the screw shafts of the multishaft machine rotating in the same direction and at the same speed, and which clean each other precisely or at least practically in pairs, have flatter screw flights than corresponding screw elements with fewer than four screw flights. These flatter screw flights in turn produce a more uniform shear, which has a beneficial effect on the quality of plastic or viscoelastic masses to be extruded. However, conventional four-flight screw elements provide the extrudate with only a small amount of volume in the housing bore, as conventional four-flight screw elements fill the housing bores more than, for example, two-flight or even three-flight screw elements with the same outer radius ra.

U.S. Pat. No. 6,783,270 B1 describes the eccentric arrangement of self-cleaning screw profiles in an enlarged housing. According to this principle, four-flight screw profiles can also be used in such a housing. However, U.S. Pat. No. 6,783,270 B1 also fails to disclose a screw profile of a four-flight screw element that has been designed for a housing with a ratio of center distance a to housing inner diameter dg of less than 0.924. Furthermore, U.S. Pat. No. 6,783,270 B1 discloses screw profiles with different crest angles, but does not disclose the exact ratios of the different crest angles to one another.

Multishaft extruders with screw shafts rotating in the same direction and at the same speed convert a large proportion of the drive power into heat (dissipation) during pressure build-up, while only a small proportion is actually converted into pressure energy. The proportion of the energy used that is converted into pressure energy is also referred to as efficiency.

### SUMMARY

The invention was based on the task of providing a screw element with which an improved mixing and dispersing effect compared to the prior art can be achieved with simultaneously good shearing and good efficiency during pressure build-up.

The present invention was also based on the task of providing a pair of four-flight screw elements
that can be used as intended in a multishaft screw machine
with m screw shafts SW1 to SWm rotating in the same direction and at the same speed, the respective neighboring axes of rotation D1 to Dm of which have a center distance a in a cross-section at right angles to the axes of rotation
and
with m circular housing bores which penetrate one another, each of which, in the cross-section perpendicular to the axes of rotation, has an identical housing inner radius rg and the bore centers M1 to Mm of which are at a distance which is the same as the center distance a, and the bore centers M1 to Mm of which coincide with the centers of the cross-sections of the respective axes of rotation D1 to Dm of the screw shafts SW1 to SWm,
wherein the housing bores have a ratio of center distance a to housing inner diameter dg of less than 0.924.

The pair of four-flight screw elements according to the invention should also provide the extrudate with more volume in the housing bore than conventional four-flight screw elements.

In addition, the two screw elements of the pair of four-flight screw elements according to the invention should practically scrape each other when used as intended.

Surprisingly, it has now been found that the problem is solved by a pair of four-flight screw elements having the features of the main claim.

### BRIEF DESCRIPTION OF DRAWINGS

FIG. 1A shows a plan view of a pair of four-flight screw elements for a co-rotating twin-screw extruder according to the invention, which practically scrape each other.

FIG. 1B shows a cross-section of the pair of four-flight screw elements from FIG. 1A.

FIG. 1C shows the practically cleaning screw profiles associated with FIGS. 1A and 1B.

FIG. 2A shows a plan view of the pair of four-flight screw elements according to the invention as a pair of screw elements that practically clean each other.

FIG. 2B shows the screw profiles of the two screw elements that clean each other precisely, which were used as the basis for the design of the practically cleaning screw elements in FIG. 2A.

FIG. 2C shows the practically cleaning screw profiles associated with FIGS. 2A and 2B.

FIG. 3A shows a plan view of the pair of four-flight screw elements as a pair of screw elements that practically clean each other.

FIG. 3B shows a cross-section of the pair of four-flight screw elements.

FIG. 3C shows the screw cross-sectional profile from FIG. 3B.

FIG. 4A shows a plan view of the pair of four-flight screw elements as a pair of screw elements that practically clean each other.

FIG. 4B shows the screw profiles of the precisely scraping screw elements on which the practically cleaning screw elements shown in FIGS. 4A and 4C are based.

FIG. 4C shows the screw cross-sectional profile of the practically cleaning screw elements from FIG. 4A.

### DETAILED DESCRIPTION

In the context of the present invention, the following terms apply:

A screw profile is a closed convex curve. A screw profile is made up of several different curves, which—depending on their geometric properties—are referred to as a “crest”, a “flank” or a “groove”. A crest is always adjacent to a flank on both sides. A groove is always adjacent to a flank on both sides. Crests and grooves, separated from each other by a flank, always occur alternately in a screw profile in the same direction. This results in the sequence crest—flank—groove—flank—crest—etc.

A curve is an unbroken line with a length, but no width, wherein a curve has a first endpoint and a second endpoint that are not one and the same point; that is to say, the first endpoint does not coincide with the second endpoint.

A curve can be composed of several curve sections, wherein a first curve section has a common point of contact with a second curve section that is directly neighboring the first curve section.

However, a curve can also consist of exactly one curve section.

A curve section is a section of a curve, wherein the curve section has a first endpoint and a second endpoint that are not one and the same point; that is to say, the first endpoint does not coincide with the second endpoint.

The mathematical expressions on which a curve section is based are selected from the group of mathematical expressions comprising the following members: circular arc, elliptical arc, parabolic arc, longitudinal equidistant calculation rule according to [1], pages 117 to 121, circular equidistant arithmetic rule and spatial equidistant arithmetic rule. To produce a constant clearance when the screw elements are cleaned against each other, the longitudinal equidistant calculation rule or the circular equidistant calculation rule is preferred.

The longitudinal equidistant calculation rule is disclosed in [1], pages 117 to 121.

The circular equidistant is based on the assumption of a precisely scraping screw profile in the x-y plane of a Cartesian coordinate system, wherein a perpendicular is dropped in the direction of the center of rotation P at each point of the screw profile. The point that is displaced by half the clearance along this perpendicular to the center of rotation then belongs to the technically executed screw profile. If a portion of a precisely scraping screw profile is a circular arc with a radius ri, the corresponding portion of the associated technically executed screw profile is a circular arc with the same center and radius ri−s/2.

The spatial equidistant is mentioned in [1], page 41; a spatial equidistant is available, for example, through a parameter representation.

A curve is an uninterrupted line with a non-zero length but no width.

A curve can have both a first endpoint and a second endpoint, but it can also have only a first or only a second endpoint or it can have no endpoint at all. If a curve has both a first endpoint and a second endpoint, these can coincide, but they do not have to. A curve that has both a first endpoint and a second endpoint has a finite length. If a curve has both a first endpoint and a second endpoint and these endpoints coincide, it is a closed curve.

As all curve sections of a screw profile are located in one plane, a closed curve, which is a screw profile, divides the area of this plane into an area inside the closed curve and an area outside the closed curve.

A circular arc is a curve section in which all points of the circular arc have the same distance, called the radius, from a common center point. An arc has a starting point and an endpoint that are not one and the same point.

A circular arc is only considered to be a circular arc if all points of this circular arc have the same center and the same radius and the points of this circular arc form an uninterrupted curve section; in other words, two directly adjacent circular arcs that have a common point of contact are only considered to be two circular arcs if they have a different center or a different radius.

The pivot point of a screw profile is the intersection of the axis of rotation of a screw element with the cross-sectional plane at right angles to this axis of rotation. The pivot point of the screw profile, hereinafter also referred to as pivot point for short, also coincides with the center of the bore of the housing bore in which the respective screw element is located or for which the respective screw element is designed.

In relation to a screw profile, a pivot point is the point around which a screw profile rotates as a cross-sectional image of a screw element.

A crest is:
(i) either exactly a circular arc of a screw profile which has the pivot point of the screw profile as center point and in which all points of this circular arc have a greater distance from the pivot point than the two curve sections immediately neighboring the crest, except for the common points of contact with the two curve sections immediately neighboring the crest;
(ii) or a point of a screw profile which has a greater distance from the pivot point than the two points immediately adjacent to this point; the point which is a crest according to this case (ii) is thus a local maximum of the screw profile with respect to the distance from the pivot point. Preferably, in case (ii), the point which is a crest is a point of a circular arc of which the radius is smaller than the distance between this point and the pivot point. Here, in case (ii), the point which is a crest can be the middle point of a circular arc of which the radius is smaller than the distance between this point and the pivot point.

In case (ii), the curves immediately adjacent to the crest merge into one another tangentially at the point that is the crest.

The crest radius is in case (i) the distance of the respective crest, which is a circular arc, from the pivot point of a screw profile, and in case (ii) is the distance of the point, which is a crest, from the construction point of the circular arc of which the center point is the point which is a crest.

A groove is:
(iii) either exactly a circular arc of a screw profile which has the pivot point of the screw profile as center point and in which all points of this circular arc have a smaller distance from the pivot point than the two curve sections immediately neighboring the groove, except for the points of contact with the two curve sections immediately neighboring the groove;
(iv) or a point of a screw profile which has a smaller distance from the pivot point than the two points immediately adjacent to this point; the point which is a crest according to this case (iv) is thus a local minimum of the screw profile with respect to the distance from the pivot point. Preferably, in case (iv), the point which is a groove is a point of a circular arc of which the radius is greater than the distance between this point and the pivot point. Here, in case (ii), the point which is a groove can be the middle point of a circular arc of which the radius is greater than the distance between this point and the pivot point.

In case (iv), the curves immediately adjacent to the groove merge into one another tangentially at the point that is the groove.

A flank is a curve of a screw profile in which all points of this curve, apart from the common point of contact with a first curve section immediately adjacent to the flank, have a smaller distance from the pivot point than this first curve section immediately adjacent to the flank and at the same time all points of this curve, apart from the common point of contact with a second curve section immediately adjacent to the flank, have a greater distance from the pivot point than this second curve section of the screw profile immediately adjacent to the flank.

A flank can be composed of several curve sections to which the above definition applies. A flank is then represented by a convex curve made up of several curve sections, wherein the radii of curvature of the curve sections are always smaller than the center distance a.

According to the invention, a flank is preferably formed from a convex curve of which the curve sections are formed exclusively from circular arcs with a radius smaller than or equal to center distance a and according to the invention, a flank is particularly preferably formed by exactly one circular arc with a radius smaller than center distance a. According to the invention, it is particularly preferred that all flanks of a screw cross-sectional profile are each formed by exactly one circular arc with a radius smaller than center distance a.

The screw profile according to the invention has exactly eight flanks. The following is preferred according to the invention:
for each of the eight flanks the following applies independently of each of the other seven flanks:
one flank is formed from exactly one single circular arc, wherein this circular arc has a center point that is not the pivot point of the screw profile,
or
one flank can be formed exclusively from a plurality of circular arcs, wherein, for the center points of all of these circular arcs, it is true that these center points are different from the pivot point of the screw profile,
or
a flank can be formed from at least one circular arc and at least one curve section that is not a circular arc, wherein no circular arc has a center point that is the pivot point of the screw profile,
or
a flank can be formed from only a single curve section that is not a circular arc,
or
a flank can be formed exclusively from a plurality of curve sections, none of which is a circular arc.

Alternatively, according to the invention, a flank is preferably formed from a convex curve of which the curve sections are formed exclusively according to a longitudinal section equidistant, circular equidistant or spatial equidistant calculation rule, and according to the invention, a flank is particularly preferably formed by exactly one curve section formed exclusively according to a longitudinal section equidistant, circular equidistant or spatial equidistant calculation rule. Alternatively, according to the invention it is particularly preferred that all flanks of a screw cross-sectional profile are formed exclusively according to a longitudinal section equidistant, circular equidistant or spatial equidistant calculation rule, and according to the invention it is particularly preferred that all flanks of a screw cross-sectional profile are each formed by exactly one curve section formed exclusively according to the longitudinal section equidistant, circular equidistant or spatial equidistant calculation rule. Alternatively, and in particular preferably, all curves of a screw profile are formed according to the same longitudinal section equidistant, circular equidistant or spatial equidistant calculation rule.

For the purposes of the present invention, a screw element is described as having four flights if it has exactly four crests.

In particular, the object is achieved by a pair of four-flight screw elements suitable for a multishaft screw machine
with m screw shafts SW1 to SWm rotating in the same direction and at the same speed, the respective neighboring axes of rotation D1 to Dm of which have a center distance a in a cross-section at right angles to the axes of rotation and
with m circular housing bores which penetrate one another, each of which has an identical housing inner radius rg and the bore centers M1 to Mm of which are at a distance which is the same as the center distance a, and the bore centers M1 to Mm of which coincide with the respective associated axes of rotation D1 to Dm of the screw shafts SW1 to SWm,
wherein each of the two screw elements of the pair of screw elements has a screw profile for which the following applies:
(1) it is a closed convex curve,
   wherein this closed convex curve is composed merely of curve sections of which the radii of curvature are less than or equal to the center distance a,
(2) it is composed of at least 16 curves,
(3) it has exactly one or no axis symmetry,
(4) it has exactly four grooves,
(5) it has exactly four crests-labeled as they revolve as K1, K2, K3 and K4,
(6) r(Ki) is the crest radius of the crest Ki, wherein the following applies:
   r(K1)>r(K2) and r(K1)>r(K3) and r(K1)>r(K4), and
   r(K3)>r(K2) and r(K3)>r(K4),
   wherein r(K1) is the crest radius of the screw crest K1 and r(K2) is the crest radius of the screw crest K2 and r(K3) is the crest radius of the screw crest K3, and r(K4) is the crest radius of the screw crest K4,
   wherein r(K1) is equal to the outer radius ra,
   and m is an integer greater than 1, preferably from 2 to 16, particularly preferably 2, 3, 4, 6, 8, 10, 12 and 16,
   and i may assume the values 1, 2, 3 or 4,
   and the outer radius ra is the radius of the circle which encloses the entire screw profile and of which the center point is the pivot point associated with this screw profile, wherein the crest K1 is a segment of this circle,
(7) two screw elements of the pair of screw elements located oppositely in pairs and directly adjacently to one another on two of the screw shafts of the multishaft screw machine, which rotate in the same direction and at the same speed, practically clean one another in pairs,
(8) a groove is separated from the nearest point of a neighboring crest by a flank,
(9) it has exactly eight curves, which are flanks.

This results in the screw profile according to the invention:

The exactly four screw crests K1, K2, K3 and K4 of the screw element according to the invention have different gaps S1, S2, S3 and S4 to the housing inner wall, wherein S1 is the gap between screw crest K1 and the housing inner wall, S2 is the gap between screw crest K2 and the housing inner wall, S3 is the gap between screw crest K3 and the housing inner wall, and S4 is the gap between screw crest K4 and the housing inner wall, wherein the following relationships apply: S1<S2 and S1<S3 and S1<S4 and S3<S4 and S3<S2.

In the context of the present invention, a gap S refers to the distance between a screw crest and the housing inner wall, thus obeying the equation Si=rg−r(Ki), that is to say S1=rg−r(K1) and S2=rg−r(K2) and S3=rg−r(K3) and S4=rg−r(K4).

The screw element according to the invention achieves an improved mixing and dispersing effect compared to the prior art, with good shearing and good efficiency during pressure build-up at the same time, and it is ensured that two screw elements according to the invention, which are located directly adjacent to each other on two directly adjacent screw shafts, practically clean each other.

Due to the larger gaps of the crests K2, K3 and K4 compared to the gap of the crest K1, the energy input is reduced in the screw element according to the invention compared to conventional screw elements known in the prior art. Surprisingly, the four-flight screw elements according to the invention nevertheless exhibit an excellent mixing and dispersing effect.

In addition, the screw elements according to the invention can be used in multishaft extruders with screw shafts rotating in the same direction and at the same speed with a ratio of center distance a to housing inner diameter dg of a/dg of less than 0.924 and are therefore relevant for industrial practice.

In a preferred embodiment according to the invention of the four-flight screw element according to the invention, the following also applies to the screw profile with the features shown under (1) to (9):
(10) each of the four crests is formed from only one curve section each, which is a circular arc of which the center point is the pivot point common to the crests K1, K2, K3 and K4,
and
each of the four grooves is formed from only one curve section, which is a circular arc of which the center point is the pivot point common to the four grooves, and wherein there is exactly one groove of which the distance from the pivot point is smaller than the distances of the other grooves from the pivot point.

For this preferred case according to the invention with the additional feature (10), it also applies that the core radius ri is the radius of the groove with the smallest radius—starting from the pivot point of the screw profile—of all grooves.

In this preferred embodiment according to the invention, the circular arcs which represent the exactly four grooves have the same center point, namely the pivot point, as do the circular arcs which represent the exactly four crests K1, K2, K3 and K4. The pivot point is therefore the common center point of all four crests K1, K2, K3 and K4 as well as of all four grooves.

As a result, in this preferred embodiment according to the invention, a screw profile has a kink at all transitions from a screw crest to a flank. A kink in the screw profile means that an edge is formed in the screw element at the corresponding point. Mathematically, a kink means that a curve is not continuously differentiable at the point of the kink.

Particularly preferably in this preferred embodiment according to the invention with the additional feature (10), the screw crest with the largest crest radius r(Ki), i.e., the crest K1, has the smallest crest angle. In this way, the energy input is reduced and the thermal load on the polymer is reduced. For the multishaft screw machine described above, this means that the screw crest with the narrowest gap to the housing, i.e., the crest K1 with the gap S1, has the smallest crest angle.

Furthermore, preferably—but irrespective of whether the additional feature (10) is present or not—the four-flight screw element according to the invention has at least one screw crest Ki, the crest angle KWi of which differs from the crest angles of the other screw crests.

Further particularly preferably, the crest angles are selected so that the screw profile has no axes of symmetry, i.e., KW2≠KW4 and KW1≠KW3, wherein KW1 is the crest angle of crest K1, KW2 is the crest angle of crest K2, KW3 is the crest angle of crest K3, and KW4 is the crest angle of crest K4.

In particular, the crest angles of all crests are preferably different from each other.

According to the invention, it is also the case that two screw elements according to the invention, which are located directly adjacent to each other in pairs on two screw shafts of the described multishaft screw machine, practically clean each other in pairs; such two screw elements according to the invention are referred to as a pair of screw elements according to the invention. The screw profiles of these two screw elements according to the invention can be the same or different.

According to the invention, it is preferred that all screw elements practically clean each other in pairs in a cross-section at right angles to the screw shafts. Of course, this applies except for the technically necessary clearances. Here, the screw profiles of these screw elements according to the invention may be the same or different.

Preferably, for a given housing inner radius rg in relation to a given center distance a, the distance r(K1) of the crest K1 from the pivot point is selected so that the following range applies for r(K1):
r(K1) is less than or equal to rg−0.001*a and r(K1) is greater than or equal to rg−0.015*a.

For the crest K3, the following range is preferred:
r(K3) is less than or equal to r(K1)−0.0015*a and r(K3) is less than or greater than r(K1)−0.03*a.

The following ranges apply preferably to both crest K2 and crest K4:
r(K2) is less than or equal to r(K1)−0.003*a and r(K2) is greater than or equal to r(K1)−0.08*a,
and
r(K4) is less than or equal to r(K1)−0.003*a and r(K4) is greater than or equal to r(K1)−0.08*a.

Here, r(K2) and r(K4) can be the same or different, preferably (K2) and r(K4) are different.

The following ranges are particularly preferred both for the crest K2 and for the crest K4:
r(K2) is less than or equal to r(K1)−0.005*a and r(K2) is greater than or equal to r(K1)−0.04*a,
and
r(K4) is less than or equal to r(K1)−0.005*a and r(K4) is greater than or equal to r(K1)−0.04*a.

Here, r(K2) and r(K4) can be the same or different, preferably (K2) and r(K4) are different.

It follows, according to the invention,
for a multishaft screw machine
with m screw shafts SW1 to SWm rotating in the same direction and at the same speed, the respective neighboring axes of rotation D1 to Dm of which each have an identical center distance a in a cross-section at right angles to the axes of rotation, and
with m circular housing bores which penetrate one another, each of which has an identical housing inner radius rg and the bore centers M1 to Mm of which are at a distance which is the same as the center distance a, and the bore centers M1 to Mm of which coincide with the respective axes of rotation D1 to Dm of the screw shafts SW1 to SWm,
that
the gap S1 is preferably from S1/a=0.001 to S1/a=0.015 in relation to the distance a between the pivot points DP1 and DP2. The gap S3 is therefore preferably from S3/a=S1/a+0.0025 to S3/a=S1/a+0.045 and particularly preferably from S3/a=S1/a+0.004 to S3/a=S1/a+0.035 in relation to the center distance a of the pivot points DP1 and DP2 as a function of S1. The pivot point DP1 is the intersection of the axis of rotation D1 with the plane of the screw profile at right angles to this axis of rotation D1 and the pivot point DP2 is the intersection of the axis of rotation D2 with the plane of the screw profile at right angles to this axis of rotation D2.

The gaps S2 and S4 are thus, in relation to the distance a between the pivot points DP1 and DP2 and depending on S1, preferably in the range S1/a+0.004 less than or equal to S2/a less than or equal to S1/a+0.095 and S1/a+0.004 less than or equal to S4/a less than or equal to S1/a+0.095, and particularly preferably S1/a+0.006 less than or equal to S2/a less than or equal to S1/a+0.055 and S1/a+0.006 less than or equal to S4/a<=S1/a+0.055.

According to the invention, the crest angle KW1 is preferably 0 degrees<KW1<8 degrees and particularly preferably 2 degrees<KW1<6 degrees.

Alternatively, according to the invention, the crest angle KW1 is preferably 0 degrees if the screw profile at the crest is continuously differentiable, i.e., the screw profile at the crest has no kink.

A further subject of the present invention is the use of a pair of the screw elements according to the invention in a multishaft machine. Preferably, the pair of screw elements according to the invention is used in a twin-shaft machine, i.e., in a twin-screw extruder.

The present invention thus also relates to a multishaft screw machine equipped with a pair of the screw elements according to the invention. The multishaft screw machine is preferably equipped here with at least as many screw elements as the screw machine has shafts. The screw elements according to the invention are arranged here on the screw shafts in such a way that each of the screw elements according to the invention practically cleans itself with at least one other of the screw elements according to the invention.

The pair of screw elements according to the invention can be present in a multishaft screw machine in the form of kneading, conveying or mixing elements. It is possible to combine kneading, conveying and mixing elements in a screw machine. The pair of screw elements according to the invention can also be combined with other screw elements, for example those known in the prior art.

As is well known, it is a feature of a conveying element (see for example [1], pages 136-142) that the screw profile has continuous helical turns continuing in axial direction. The conveying element may be right-handed or left-handed. The pitch of a conveying element according to the invention preferably lies in the range of 0.5 to 5 times the center distance a, and the axial length of a conveying element according to the invention is preferably in the range of 0.25 to 2 times the pitch. The length of the conveying element is particularly preferably equal to the pitch; the conveying element thus represents a complete rotation of the screw profile.

As is well known, it is a feature of a kneading element (see for example [1], pages 142-145) that a screw profile is continued in the axial direction in an offset manner axis-parallel in the form of kneading disks. The kneading disks can be arranged to be either right-handed or left-handed, resulting in either a conveying effect or a reverse conveying effect. An offset angle of 45° between two axially adjacent kneading disks results in a neutral arrangement without conveying effect for four-flight screws. The axial length of the kneading disks preferably lies in the range of 0.05 to 0.5 times the center distance a. The axial distance between two adjacent kneading disks lies preferably in the range of 0.0005 to 0.02 times the center distance a.

As is well known inter alia (see for example [1], pages 148-151), mixing elements are formed in that conveying elements are provided with apertures in the screw flight lands. The mixing elements may be right-handed or left-handed. Their pitch is preferably in the range of 0.1 times to 10 times the center distance a and the axial length of the elements is preferably in the range of 0.5 times to 5 times the center distance a. The apertures are preferably in the form of u-shaped or v-shaped grooves, which are preferably arranged in a counter-conveying or axis-parallel manner.

The sequence of the screw elements consisting of conveying elements and/or kneading elements and/or mixing elements on a screw shaft is also referred to as screw configuration.

The screw element according to the invention may also be configured as a transition element, meaning that the screw profile at any point in the axial extent of the screw element is different than at another point in the axial extent of the screw element, with these different screw profiles not being interconvertible by rotation.

The screw element according to the invention is suitable for the extrusion of plastic and viscoelastic masses, e.g., suspensions, pastes, glass, ceramic masses, metals in the form of a melt, plastics, plastic melts, polymer solutions, elastomer and rubber masses.

The present invention thus also relates to a multishaft screw machine equipped with at least one pair of the screw elements according to the invention.

The present invention therefore also relates to a method for extruding plastic or viscoelastic masses using a pair of screw elements according to the invention or using a screw machine equipped with a pair of screw elements according to the invention.

A plastic mass is understood to be a deformable mass. Examples of plastic masses are polymer melts, especially of thermoplastics, as well as elastomers, mixtures of polymer melts or dispersions of polymer melts with solids, liquids or gases.

Thermoplastic polymers, also known as thermoplastics, or mixtures of thermoplastic polymers from the following series are preferably used: polycarbonate, polyamide, polyester, in particular polybutylene terephthalate and polyethylene terephthalate, and polyether, thermoplastic polyurethane, polyacetal, fluoropolymer, in particular polyvinylidene fluoride, and polyether sulfones, polyolefin, in particular polyethylene and polypropylene, and polyimide, polyacrylate, in particular poly(methyl) methacrylate, and polyphenylene oxide, polyphenylene sulfide, polyetherketone, polyaryletherketone, styrene polymers, in particular polystyrene, and styrene copolymers, in particular styrene-acrylonitrile copolymer, and acrylonitrile-butadiene-styrene block copolymers and also polyvinyl chloride. Similarly preferably used are what are known as blends of the plastics listed, which a person skilled in the art understands to be a combination of two or more plastics.

Viscoelastic masses are materials and mixtures that exhibit time-, temperature- and frequency-dependent elasticity. Viscoelasticity is characterized by a partly elastic, partly viscous behavior. The material only relaxes incompletely after the external force is removed, the remaining energy is dissipated in the form of flow processes (retardation).

Examples of viscoelastic materials are styrene-butadiene rubber, natural rubber, butadiene rubber, isoprene rubber, ethylene-propylene-diene rubber, ethylene-propylene rubber, butadiene-acrylonitrile rubber, hydrogenated nitrile rubber, butyl rubber, halobutyl rubber, chloroprene rubber, ethylene-vinyl acetate rubber, polyurethane rubber, thermoplastic polyurethane, gutta-percha, arylate rubber, fluorinated rubber, silicone rubber, sulfide rubber and chlorosulfonyl polyethylene rubber. A combination of two or more of the rubbers listed, or a combination of one or more rubbers with one or more plastics, is of course also possible.

The plastic or viscoelastic masses to be extruded may be used in pure form or as mixtures with fillers and reinforcers, such as in particular glass fibers, as mixtures with one another or with other polymers, or as mixtures with customary polymer additives.

Additives may be added to the extruder in solid, liquid or solution form together with the polymer, or else at least some or all of the additives are fed to the extruder via a side stream.

Additives can provide a polymer with a wide variety of properties. Said additives may, for example, be plasticizers, colorants, pigments, processing aids, fillers, antioxidants, reinforcers, UV absorbers and light stabilizers, extender oils, metal deactivators, peroxide scavengers, basic stabilizers, nucleating agents, benzofurans and indolinones which have a stabilizing or antioxidant action, mold release agents, flame retardant additives, antistatic agents, dyes and melt stabilizers. Examples of fillers and reinforcers are carbon black, glass fibers, clay, mica, graphite fibers, titanium dioxide, carbon fibers, carbon nanotubes, ionic liquids and natural fibers.

As explained above, the pair of screw elements according to the invention are particularly suitable for the extrusion of viscoelastic masses. The method steps that can be carried out with the aid of this pair of screw elements are, for example, the mixing or dispersing of solids or liquids or gases. Solids can be, for example, the solid additives mentioned above. Liquids can be, for example, the abovementioned additives in liquid form, but also, for example, water. Gases can be nitrogen or carbon dioxide, for example.

In particular, a pair of screw elements according to the invention or a single-shaft or multishaft screw machine equipped with at least one pair of screw elements according to the invention can also be advantageously used for compounding thermoplastics, in particular polycarbonates or thermoplastic polyurethanes, with colorants, pigments or additives.

The present invention thus relates both to a method for compounding thermoplastics, in particular polycarbonates or thermoplastic polyurethanes, with colorants and additives using a pair of screw elements according to the invention and the use of a pair of screw elements according to the invention for compounding thermoplastics, in particular polycarbonates or thermoplastic polyurethanes, with colorants and additives.

The invention is explained below by way of example with reference to the accompanying drawings with the aid of preferred exemplary embodiments and the features specified below may constitute an aspect of the invention either individually or in combination.

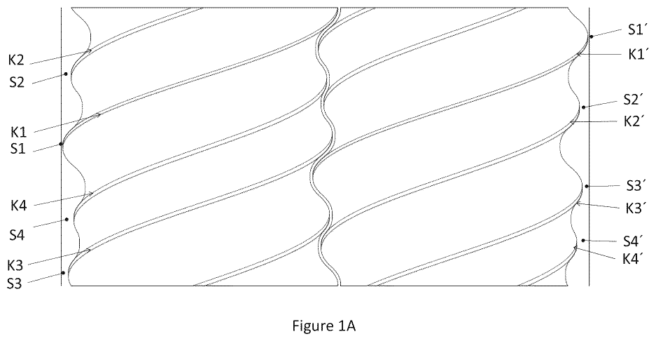

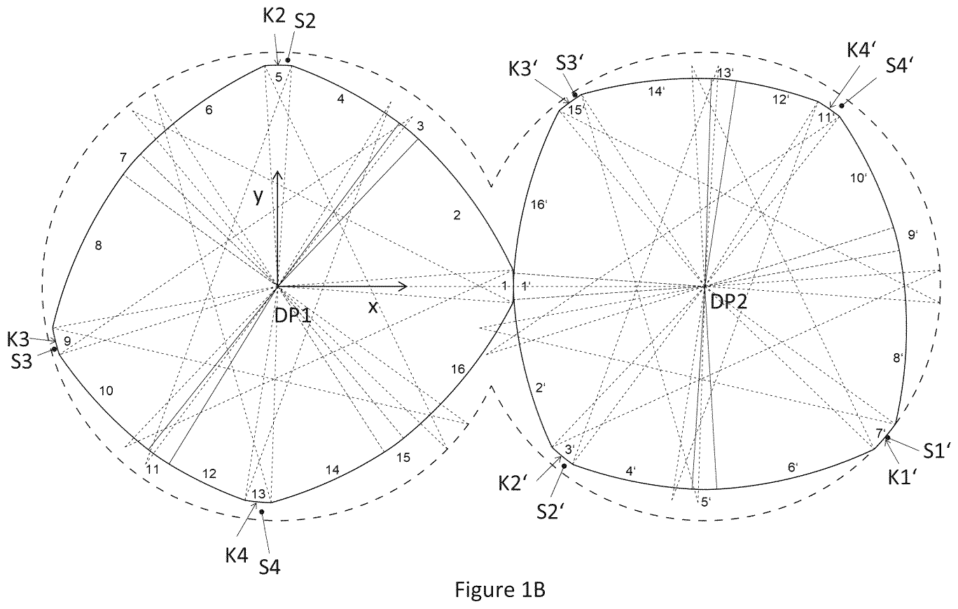

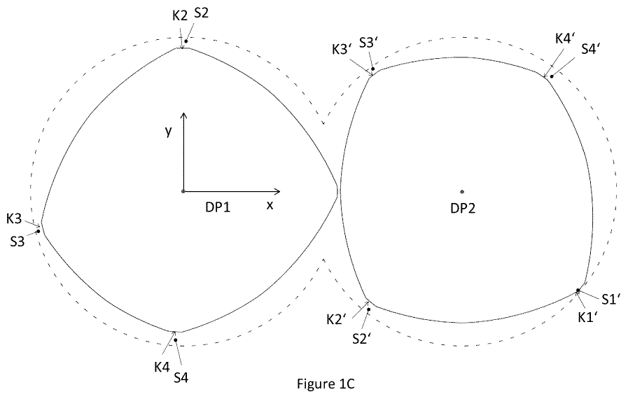

FIG. 1A shows a plan view of a pair of four-flight screw elements for a co-rotating twin-screw extruder according to the invention, which practically scrape each other. The housing wall is indicated by vertical lines in FIG. 1A.

The screw crests are labeled K1 to K4 on the left-hand screw element and K1′ to K4′ on the right-hand screw element. The screw crest K1 cleans the housing with the gap S1, K2 with the gap S2, etc. The ratio a/dg of center distance a to housing inner diameter dg is 0.899 and is therefore less than 0.924.

FIG. 1B shows a cross-section of the pair of four-flight screw elements from FIG. 1A, i.e., it shows the screw cross-sectional profiles of these screw elements. The pivot points of the twin screw are again labeled DP1 and DP2. FIG. 1B shows the screw profiles of two screw elements that clean each other precisely, i.e. there is no clearance between the screw elements when the screw elements clean each other. Similarly, the gap S1 or S1′ between the screw crest K1 or K1′ and the housing (shown here by a dashed line) is zero. In practice, a gap S1 or S1′ other than zero will be set here, just as the aim is to set a clearance between the screw elements. As already mentioned further above, the procedure for this is presented, for example, in [1] on pages 40 and 41 and also 117 to 121. The circular arcs that make up the screw profiles are labeled with the numbers 1 to 16 for the left-hand screw profile and with the numbers 1′ to 16′ for the right-hand screw profile. The gaps between the screw crests and the housing wall are labeled S1 to S4 for the left-hand screw element and S1′ to S4′ for the right-hand screw element. The gap S1 cannot be seen in the illustration in FIG. 1B because the left-hand screw element is cleaning the neighboring screw element in the position shown.

The screw profiles of the screw elements in FIG. 1B consist only of circular arcs. The following table 1B lists the radii, the center angles, the coordinates of the circle centers (MP) and the coordinates of the starting points (SP) of the respective circular arcs for the screw profiles in FIG. 1B with the circular arcs 1 to 16 and 1′ to 16′. The circular arcs are numbered counterclockwise for the generating screw profile, in this case the left-hand screw profile, and clockwise for the generated screw profile, in this case the right-hand screw profile. All length dimensions are normalized to the distance a between the pivot points DP1 and DP2. The origin of the coordinates is located at the pivot point of the respective screw profile. The center angles-referred to here as angles for short—are given in radians.

TABLE 1B
Coordinates of the screw profiles in FIG. 1B

| No. | Radius | Angle | SP-x | Sp-y | MP-x | MP-y |
|---|---|---|---|---|---|---|
| 1 | 0.555556 | 0.104720 | 0.555556 | 0.000000 | 0.000000 | 0.000000 |
| 2 | 1.000000 | 0.394862 | 0.552512 | 0.058071 | −0.336916 | −0.399003 |
| 3 | 0.477778 | 0.123590 | 0.308243 | 0.365045 | 0.000000 | 0.000000 |
| 4 | 1.000000 | 0.292775 | 0.260890 | 0.400260 | −0.285159 | −0.437493 |
| 5 | 0.522222 | 0.123590 | −0.004130 | 0.522206 | 0.000000 | 0.000000 |
| 6 | 1.000000 | 0.369983 | −0.068474 | 0.517714 | 0.433916 | −0.346928 |
| 7 | 0.444444 | 0.104720 | −0.347133 | 0.277542 | 0.000000 | 0.000000 |
| 8 | 1.000000 | 0.398155 | −0.374242 | 0.239736 | 0.467803 | −0.299670 |
| 9 | 0.533333 | 0.123590 | −0.517514 | −0.128934 | 0.000000 | 0.000000 |
| 10 | 1.000000 | 0.299258 | −0.497672 | −0.191747 | 0.295870 | 0.416768 |
| 11 | 0.488889 | 0.123590 | −0.283006 | −0.398647 | 0.000000 | 0.000000 |
| 12 | 1.000000 | 0.208894 | −0.231704 | −0.430494 | 0.242236 | 0.450062 |
| 13 | 0.511111 | 0.123590 | −0.038793 | −0.509637 | 0.000000 | 0.000000 |
| 14 | 1.000000 | 0.286428 | 0.024329 | −0.510532 | −0.315632 | 0.429908 |
| 15 | 0.466667 | 0.123590 | 0.276178 | −0.376169 | 0.000000 | 0.000000 |
| 16 | 1.000000 | 0.415747 | 0.320444 | −0.339254 | −0.366222 | 0.387719 |
| No. | Radius | Angle | SP-x | Sp-y | MP-x | MP-y |
| 1′ | 0.444444 | 0.104720 | −0.444444 | 0.000000 | 0.000000 | 0.000000 |
| 2′ | 1.000000 | 0.369983 | −0.442010 | −0.046457 | 0.552512 | 0.058071 |
| 3′ | 0.522222 | 0.123590 | −0.336916 | −0.399003 | 0.000000 | 0.000000 |
| 4′ | 1.000000 | 0.292775 | −0.285159 | −0.437493 | −0.004130 | 0.522206 |
| 5′ | 0.477778 | 0.123590 | 0.003778 | −0.477763 | 0.000000 | 0.000000 |
| 6′ | 1.000000 | 0.394862 | 0.062646 | −0.473653 | −0.068474 | 0.517714 |
| 7′ | 0.555556 | 0.104720 | 0.433916 | −0.346928 | 0.000000 | 0.000000 |
| 8′ | 1.000000 | 0.415747 | 0.467803 | −0.299670 | −0.517514 | −0.128934 |
| 9′ | 0.466667 | 0.123590 | 0.452825 | 0.112817 | 0.000000 | 0.000000 |
| 10′ | 1.000000 | 0.286428 | 0.435463 | 0.167779 | −0.497672 | −0.191747 |
| 11′ | 0.511111 | 0.123590 | 0.295870 | 0.416768 | 0.000000 | 0.000000 |
| 12′ | 1.000000 | 0.208894 | 0.242236 | 0.450062 | −0.038793 | −0.509637 |
| 13′ | 0.488889 | 0.123590 | 0.037106 | 0.487479 | 0.000000 | 0.000000 |
| 14′ | 1.000000 | 0.299258 | −0.023271 | 0.488335 | 0.024329 | −0.510532 |
| 15′ | 0.533333 | 0.123590 | −0.315632 | 0.429908 | 0.000000 | 0.000000 |
| 16′ | 1.000000 | 0.398155 | −0.366222 | 0.387719 | 0.555556 | 0.000000 |

FIG. 1C shows the practically cleaning screw profiles associated with FIGS. 1A and 1B, which are used as the basis for manufacturing the screw elements. These screw profiles were calculated in such a way that the screw elements clean each other spatially with an equidistant clearance, i.e., were calculated using the spatial equidistant calculation rule. Alternatively, such screw profiles that practically clean each other can also be calculated using the longitudinal equidistant calculation rule.

TABLE 1C
Cartesian coordinates of the practically cleaning screw profiles
in FIG. 1C, read off in 2° steps in a mathematically positive
directional sense, in millimeters [mm], for screw elements
for a twin-screw extruder with a housing inner diameter of 100
mm and a center distance of 90 mm. The pitch of the screw elements
is 100 mm, the clearance between the screw elements is 1 mm, the
gap between the screw elements and the housing is 0.5 mm.

| | |
|---|---|
| Left shaft | Right shaft |

| x (mm) | y (mm) | x (mm) | y (mm) |
|---|---|---|---|
| 49.156 | 0.000 | 42.141 | 0.000 |
| 49.495 | 0.726 | 41.944 | 1.465 |
| 49.306 | 4.383 | 41.723 | 2.918 |
| 48.928 | 5.143 | 41.479 | 4.360 |
| 48.093 | 6.759 | 41.212 | 5.792 |
| 47.240 | 8.330 | 40.920 | 7.215 |
| 46.372 | 9.857 | 40.606 | 8.631 |
| 45.487 | 11.341 | 40.267 | 10.040 |
| 44.588 | 12.786 | 39.892 | 11.439 |
| 43.676 | 14.191 | 39.469 | 12.824 |
| 42.750 | 15.560 | 38.997 | 14.194 |
| 41.811 | 16.893 | 38.481 | 15.547 |
| 40.859 | 18.192 | 37.938 | 16.891 |
| 39.895 | 19.458 | 37.371 | 18.227 |
| 38.919 | 20.694 | 36.780 | 19.556 |
| 37.931 | 21.899 | 36.165 | 20.880 |
| 36.930 | 23.076 | 35.524 | 22.198 |
| 35.916 | 24.226 | 34.858 | 23.512 |
| 34.890 | 25.349 | 34.165 | 24.822 |
| 33.851 | 26.447 | 33.444 | 26.129 |
| 32.798 | 27.521 | 32.695 | 27.434 |
| 31.732 | 28.572 | 31.916 | 28.737 |
| 30.651 | 29.600 | 31.106 | 30.039 |
| 29.556 | 30.606 | 30.265 | 31.340 |
| 28.445 | 31.592 | 29.390 | 32.641 |
| 27.415 | 32.476 | 28.481 | 33.942 |
| 26.166 | 33.490 | 27.535 | 35.243 |
| 24.981 | 34.383 | 26.551 | 36.545 |
| 23.766 | 35.234 | 25.948 | 37.376 |
| 22.524 | 36.045 | 24.111 | 38.586 |
| 20.989 | 36.992 | 22.750 | 39.404 |
| 19.992 | 37.600 | 21.296 | 40.051 |
| 18.703 | 38.346 | 19.262 | 40.730 |
| 17.396 | 39.073 | 18.212 | 40.906 |
| 16.072 | 39.779 | 16.680 | 41.285 |
| 14.728 | 40.465 | 15.153 | 41.634 |
| 13.365 | 41.132 | 13.631 | 41.953 |
| 11.980 | 41.779 | 12.113 | 42.242 |
| 10.573 | 42.406 | 10.597 | 42.503 |
| 9.143 | 43.013 | 9.084 | 42.736 |
| 7.688 | 43.600 | 7.572 | 42.942 |
| 6.207 | 44.166 | 6.060 | 43.120 |
| 4.699 | 44.711 | 4.548 | 43.271 |
| 3.163 | 45.235 | 3.034 | 43.394 |
| 1.597 | 45.736 | 1.518 | 43.474 |
| 0.000 | 46.214 | 0.607 | 43.496 |
| −1.623 | 46.472 | −1.518 | 43.474 |
| −3.244 | 46.387 | −3.035 | 43.399 |
| −3.851 | 46.340 | −4.551 | 43.296 |
| −6.407 | 45.591 | −6.067 | 43.167 |
| −7.885 | 44.721 | −7.434 | 43.036 |
| −10.600 | 43.547 | −9.103 | 42.825 |
| −10.708 | 42.948 | −10.624 | 42.612 |
| −12.057 | 42.048 | −12.150 | 42.371 |
| −13.366 | 41.138 | −13.679 | 42.101 |
| −14.639 | 40.219 | −15.214 | 41.801 |
| −15.875 | 39.293 | −16.755 | 41.471 |
| −17.078 | 38.358 | −18.303 | 41.110 |
| −18.249 | 37.415 | −19.859 | 40.716 |
| −19.388 | 36.464 | −21.423 | 40.290 |
| −20.499 | 35.505 | −22.996 | 39.830 |
| −21.582 | 34.538 | −24.578 | 39.334 |
| −22.638 | 33.562 | −26.171 | 38.801 |
| −23.669 | 32.577 | −27.775 | 38.230 |
| −24.675 | 31.583 | −29.244 | 37.431 |
| −25.659 | 30.579 | −30.532 | 36.387 |
| −26.620 | 29.565 | −31.784 | 35.299 |
| −27.560 | 28.540 | −32.598 | 33.756 |
| −28.480 | 27.503 | −33.269 | 32.127 |
| −29.381 | 26.455 | −33.894 | 30.518 |
| −30.263 | 25.394 | −34.476 | 28.929 |
| −31.126 | 24.319 | −35.018 | 27.359 |
| −31.956 | 23.218 | −35.521 | 25.807 |
| −32.747 | 22.088 | −35.987 | 24.273 |
| −33.499 | 20.933 | −36.418 | 22.756 |
| −33.680 | 20.680 | −36.816 | 21.255 |
| −34.938 | 18.577 | −37.181 | 19.770 |
| −35.760 | 17.110 | −37.516 | 18.298 |
| −36.306 | 16.164 | −37.822 | 16.839 |
| −36.964 | 14.934 | −38.099 | 15.393 |
| −37.605 | 13.687 | −38.349 | 13.958 |
| −38.230 | 12.422 | −38.573 | 12.533 |
| −38.838 | 11.137 | −38.771 | 11.117 |
| −39.429 | 9.831 | −38.944 | 9.710 |
| −40.004 | 8.503 | −39.093 | 8.310 |
| −40.562 | 7.152 | −39.218 | 6.915 |
| −41.103 | 5.777 | −39.320 | 5.526 |
| −41.627 | 4.375 | −39.399 | 4.141 |
| −42.133 | 2.946 | −39.455 | 2.759 |
| −42.620 | 1.488 | −39.489 | 1.379 |
| −43.089 | 0.000 | −39.500 | 0.000 |
| −43.538 | −1.520 | −39.476 | −1.379 |
| −43.966 | −3.074 | −39.404 | −2.755 |
| −44.372 | −4.664 | −39.284 | −4.129 |
| −44.755 | −6.290 | −39.128 | −5.499 |
| −45.114 | −7.955 | −38.951 | −6.868 |
| −45.447 | −9.660 | −38.750 | −8.237 |
| −45.753 | −11.407 | −38.527 | −9.606 |
| −45.660 | −13.093 | −38.281 | −10.977 |
| −45.175 | −14.678 | −38.011 | −12.350 |
| −44.635 | −16.246 | −37.716 | −13.728 |
| −43.676 | −17.646 | −37.397 | −15.109 |
| −42.629 | −18.980 | −37.052 | −16.496 |
| −41.572 | −20.276 | −36.680 | −17.890 |
| −40.503 | −21.536 | −36.282 | −19.291 |
| −39.423 | −22.761 | −35.855 | −20.701 |
| −38.333 | −23.953 | −35.398 | −22.119 |
| −37.232 | −25.113 | −34.911 | −23.548 |
| −36.120 | −26.242 | −34.392 | −24.987 |
| −34.996 | −27.342 | −33.840 | −26.438 |
| −33.862 | −28.413 | −33.252 | −27.902 |
| −32.716 | −29.457 | −32.628 | −29.379 |
| −31.557 | −30.475 | −31.966 | −30.869 |
| −30.387 | −31.466 | −31.263 | −32.374 |
| −29.203 | −32.433 | −30.518 | −33.894 |
| −28.006 | −33.376 | −29.728 | −35.429 |
| −26.795 | −34.296 | −29.415 | −36.014 |
| −25.175 | −35.477 | −27.332 | −37.619 |
| −24.325 | −36.063 | −26.002 | −38.550 |
| −23.051 | −36.890 | −24.411 | −39.066 |
| −21.750 | −37.672 | −23.026 | −39.389 |
| −20.422 | −38.408 | −21.228 | −39.924 |
| −18.226 | −39.517 | −19.656 | −40.301 |
| −17.717 | −39.794 | −18.096 | −40.645 |
| −16.344 | −40.452 | −16.548 | −40.957 |
| −14.955 | −41.088 | −15.009 | −41.237 |
| −13.549 | −41.701 | −13.480 | −41.488 |
| −12.127 | −42.291 | −11.960 | −41.710 |
| −10.686 | −42.859 | −10.448 | −41.903 |
| −9.226 | −43.404 | −8.942 | −42.068 |
| −7.745 | −43.927 | −7.442 | −42.206 |
| −6.244 | −44.426 | −5.947 | −42.317 |
| −4.719 | −44.903 | −4.457 | −42.402 |
| −3.172 | −45.355 | −2.969 | −42.461 |
| −1.588 | −45.472 | −1.484 | −42.494 |
| −0.199 | −45.500 | 0.000 | −42.501 |
| 1.588 | −45.466 | 1.483 | −42.474 |
| 3.141 | −44.915 | 2.965 | −42.396 |
| 4.661 | −44.342 | 4.442 | −42.267 |
| 7.071 | −43.611 | 5.915 | −42.087 |
| 7.607 | −43.140 | 7.383 | −41.874 |
| 9.036 | −42.511 | 8.850 | −41.635 |
| 10.438 | −41.863 | 10.747 | −41.260 |
| 11.813 | −41.198 | 11.779 | −41.079 |
| 13.164 | −40.515 | 13.244 | −40.760 |
| 14.492 | −39.815 | 14.710 | −40.415 |
| 15.796 | −39.098 | 16.178 | −40.042 |
| 17.080 | −38.363 | 17.649 | −39.641 |
| 18.344 | −37.610 | 19.124 | −39.210 |
| 19.588 | −36.840 | 20.603 | −38.749 |
| 20.814 | −36.051 | 22.087 | −38.257 |
| 22.023 | −35.245 | 23.578 | −37.733 |
| 23.216 | −34.419 | 25.075 | −37.175 |
| 24.393 | −33.574 | 26.579 | −36.583 |
| 25.550 | −32.702 | 28.092 | −35.956 |
| 26.676 | −31.791 | 29.612 | −35.291 |
| 27.769 | −30.841 | 31.142 | −34.587 |
| 28.829 | −29.854 | 32.681 | −33.842 |
| 29.869 | −28.844 | 34.229 | −33.055 |
| 30.892 | −27.816 | 35.788 | −32.224 |
| 31.900 | −26.768 | 37.356 | −31.346 |
| 32.894 | −25.699 | 38.935 | −30.419 |
| 33.873 | −24.610 | 40.046 | −29.095 |
| 34.837 | −23.498 | 41.037 | −27.680 |
| 35.789 | −22.363 | 41.496 | −25.929 |
| 36.727 | −21.204 | 41.519 | −24.594 |
| 37.652 | −20.020 | 42.045 | −22.356 |
| 38.564 | −18.809 | 42.114 | −20.906 |
| 39.463 | −17.570 | 42.436 | −18.894 |
| 40.349 | −16.302 | 42.577 | −17.202 |
| 41.223 | −15.004 | 42.683 | −15.535 |
| 42.083 | −13.674 | 42.757 | −13.893 |
| 42.930 | −12.310 | 42.800 | −12.273 |
| 43.764 | −10.912 | 42.813 | −10.674 |
| 44.583 | −9.476 | 42.796 | −9.097 |
| 45.388 | −8.003 | 42.752 | −7.538 |
| 46.176 | −6.490 | 42.681 | −5.998 |
| 46.949 | −4.935 | 42.584 | −4.476 |
| 47.704 | −3.336 | 42.461 | −2.969 |
| 48.440 | −1.692 | 42.313 | −1.478 |
| 49.156 | 0.000 | 42.141 | 0.000 |

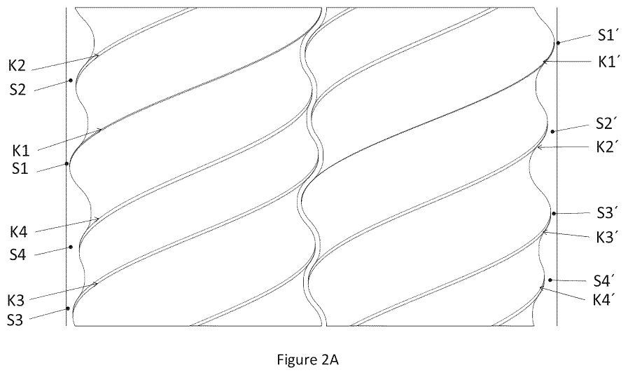

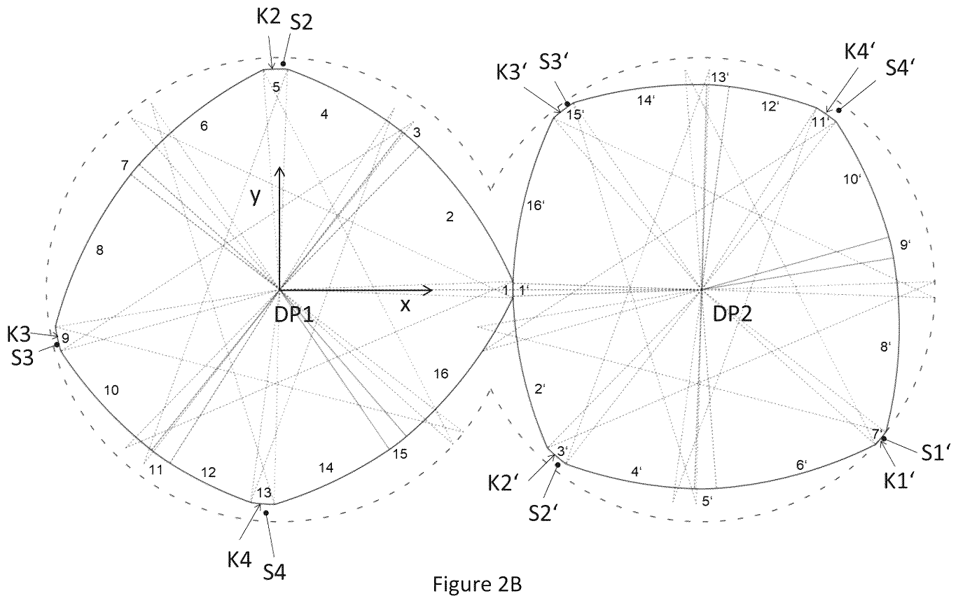

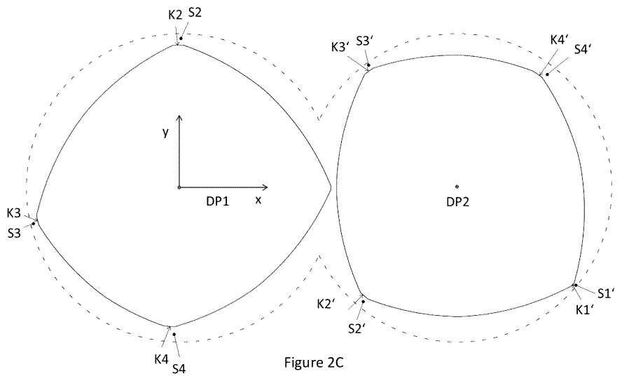

FIGS. 2A to 2C show a further example of four-flight screw elements. FIGS. 2A to 2C show an embodiment in which the crest angle of the screw crest which has the narrowest gap to the housing wall, namely the crest K1, is the smallest; this is preferred according to the invention. The ratio a/dg of center distance a to housing inner diameter dg is also 0.899 here and is therefore less than 0.924.

The pair of four-flight screw elements shown in FIGS. 2A to 2C is also characterized by the following dimensionless parameters: pitch/housing inner diameter dg=1.232, housing gap/housing inner diameter dg=0.0123, screw gap/housing inner diameter dg=0.0185.

FIG. 2A shows a plan view of the pair of four-flight screw elements according to the invention as a pair of screw elements that practically clean each other. The housing wall is indicated by vertical lines in FIG. 2A. The crests K1 to K4 and K1′ to K4′ as well as the gaps S1 to S4 and S1′ to S4′ are marked in the figure.

FIG. 2B shows the screw profiles of the two screw elements that clean each other precisely, which were used as the basis for the design of the practically cleaning screw elements in FIG. 2A. Here there is no play between the screw elements when the screw elements clean each other. The pivot points of the two screw elements of the pair of screw elements are again labeled DP1 and DP2. Similarly, the gap S1 or S1′ between the screw crest K1 or K1′ and the housing (shown here by a dashed line) is zero. The circular arcs that make up the screw profiles are labeled with the numbers 1 to 16 for the left-hand screw profile and with the numbers 1′ to 16′ for the right-hand screw profile. The gaps between the screw crests and the housing wall are labeled S1 to S4 for the left-hand screw element and S1′ to S4′ for the right-hand screw element. The gap S1 cannot be seen in the illustration in FIG. 2B because the left-hand screw element is cleaning the neighboring screw element in the position shown.

The screw profiles of the screw elements in FIG. 2B consist only of circular arcs. The following table 2 lists the radii, the angles, the coordinates of the circle centers (MP) and the coordinates of the starting points (SP) of the respective circular arcs for the screw profiles in FIG. 2 with the circular arcs 1 to 16 and 1′ to 16′. All length dimensions are normalized to the center distance a between the pivot points DP1 and DP2. The origin of the coordinates is located at the pivot point of the respective screw profile. The center angles—referred to here as angles for short—are given in radians.

TABLE 2B
Coordinates of the screw profiles in FIG. 2B

| No. | Radius | Angle | SP-x | SP-y | MP-x | MP-y |
|---|---|---|---|---|---|---|
| 1 | 0.552740 | 0.069814 | 0.555828 | −0.019290 | 0.003425 | 0.000000 |
| 2 | 1.000000 | 0.393303 | 0.555828 | 0.019290 | −0.362196 | −0.377235 |
| 3 | 0.474658 | 0.110021 | 0.333770 | 0.340839 | 0.003425 | 0.000000 |
| 4 | 1.000000 | 0.311874 | 0.294349 | 0.375050 | −0.318566 | −0.415099 |
| 5 | 0.525342 | 0.110021 | 0.022331 | 0.525002 | 0.003425 | 0.000000 |
| 6 | 1.000000 | 0.372822 | −0.035428 | 0.523904 | 0.415074 | −0.368872 |
| 7 | 0.447260 | 0.069814 | −0.329669 | 0.298480 | 0.003425 | 0.000000 |
| 8 | 1.000000 | 0.407502 | −0.349679 | 0.274517 | 0.439802 | −0.339258 |
| 9 | 0.539041 | 0.110021 | −0.528281 | −0.088627 | 0.003425 | 0.000000 |
| 10 | 1.000000 | 0.320394 | −0.515335 | −0.146472 | 0.321806 | 0.400516 |
| 11 | 0.488356 | 0.110021 | −0.300465 | −0.382286 | 0.003425 | 0.000000 |
| 12 | 1.000000 | 0.213750 | −0.256653 | −0.413341 | 0.275905 | 0.433052 |
| 13 | 0.511644 | 0.110021 | −0.064991 | −0.507049 | 0.003425 | 0.000000 |
| 14 | 1.000000 | 0.303574 | −0.008904 | −0.511495 | −0.300883 | 0.444930 |
| 15 | 0.460959 | 0.110021 | 0.263652 | −0.380480 | 0.003425 | 0.000000 |
| 16 | 1.000000 | 0.418497 | 0.303855 | −0.349607 | −0.347896 | 0.408827 |
| No. | Radius | Angle | SP-x | SP-y | MP-x | MP-y |
| 1′ | 0.447260 | 0.069814 | −0.443563 | 0.015609 | 0.003425 | −0.000000 |
| 2′ | 1.000000 | 0.372822 | −0.443563 | −0.015609 | 0.555828 | 0.019290 |
| 3′ | 0.525342 | 0.110021 | −0.362196 | −0.377235 | 0.003425 | −0.000000 |
| 4′ | 1.000000 | 0.311874 | −0.318566 | −0.415099 | 0.022331 | 0.525002 |
| 5′ | 0.474658 | 0.110021 | −0.013657 | −0.474350 | 0.003425 | −0.000000 |
| 6′ | 1.000000 | 0.393303 | 0.038529 | −0.473358 | −0.035428 | 0.523904 |
| 7′ | 0.552740 | 0.069814 | 0.415074 | −0.368872 | 0.003425 | −0.000000 |
| 8′ | 1.000000 | 0.418498 | 0.439802 | −0.339258 | −0.528281 | −0.088627 |
| 9′ | 0.460959 | 0.110021 | 0.458110 | 0.075789 | 0.003425 | −0.000000 |
| 10′ | 1.000000 | 0.303574 | 0.447040 | 0.125255 | −0.515335 | −0.146472 |
| 11′ | 0.511644 | 0.110021 | 0.321806 | 0.400516 | 0.003425 | −0.000000 |
| 12′ | 1.000000 | 0.213750 | 0.275905 | 0.433052 | −0.064991 | −0.507049 |
| 13′ | 0.488356 | 0.110021 | 0.068727 | 0.483970 | 0.003425 | −0.000000 |
| 14′ | 1.000000 | 0.320394 | 0.015192 | 0.488214 | −0.008904 | −0.511495 |
| 15′ | 0.539041 | 0.110021 | −0.300883 | 0.444930 | 0.003425 | −0.000000 |
| 16′ | 1.000000 | 0.407502 | −0.347896 | 0.408827 | 0.555828 | −0.019290 |

FIG. 2C shows the practically cleaning screw profiles associated with FIGS. 2A and 2B, which are used as the basis for manufacturing the screw elements. These screw profiles were calculated in such a way that the screw elements clean each other spatially with an equidistant clearance, i.e., were calculated using the spatial equidistant calculation rule. Alternatively, such screw profiles that practically clean each other can also be calculated using the longitudinal equidistant calculation rule.

TABLE 2C
Cartesian coordinates of the practically cleaning screw profiles
in FIG. 2C, read off in 2° steps in a mathematically positive
directional sense, in millimeters [mm], for screw elements
for a twin-screw extruder with a housing inner diameter of 162.4
mm and a center distance of 146 mm. The pitch of the screw elements
is 200 mm, the clearance between the screw elements is 3 mm,
the gap between the screw elements and the housing is 2 mm.

| | |
|---|---|
| Left shaft | Right shaft |

| x (mm) | y (mm) | x (mm) | y (mm) |
|---|---|---|---|
| 78.418 | 0.000 | 66.485 | 0.000 |
| 79.178 | 1.852 | 66.225 | 2.313 |
| 79.109 | 3.786 | 65.928 | 4.610 |
| 78.346 | 5.479 | 65.594 | 6.894 |
| 77.101 | 8.104 | 65.221 | 9.166 |
| 75.825 | 10.657 | 64.811 | 11.428 |
| 74.521 | 13.140 | 64.486 | 13.085 |
| 73.191 | 15.557 | 63.845 | 15.918 |
| 71.835 | 17.911 | 62.664 | 20.071 |
| 70.455 | 20.203 | 62.580 | 20.333 |
| 69.053 | 22.437 | 61.856 | 22.514 |
| 67.627 | 24.614 | 61.095 | 24.684 |
| 66.180 | 26.738 | 60.296 | 26.845 |
| 64.711 | 28.811 | 59.457 | 28.999 |
| 63.221 | 30.835 | 58.579 | 31.147 |
| 61.710 | 32.812 | 57.660 | 33.290 |
| 60.177 | 34.743 | 56.699 | 35.430 |
| 58.623 | 36.632 | 55.695 | 37.567 |
| 57.048 | 38.479 | 54.646 | 39.702 |
| 55.450 | 40.287 | 53.550 | 41.838 |
| 53.830 | 42.057 | 52.407 | 43.974 |
| 52.187 | 43.790 | 51.213 | 46.113 |
| 50.520 | 45.488 | 49.968 | 48.254 |
| 48.828 | 47.153 | 48.669 | 50.398 |
| 47.111 | 48.785 | 47.313 | 52.546 |
| 45.446 | 50.314 | 45.898 | 54.700 |
| 43.581 | 51.938 | 44.422 | 56.858 |
| 41.742 | 53.427 | 42.882 | 59.022 |
| 39.670 | 54.983 | 42.414 | 59.660 |
| 37.923 | 56.223 | 37.624 | 62.791 |
| 35.968 | 57.561 | 36.475 | 63.176 |
| 33.988 | 58.868 | 34.010 | 63.964 |
| 31.979 | 60.144 | 31.556 | 64.699 |
| 29.941 | 61.389 | 29.111 | 65.383 |
| 27.873 | 62.604 | 26.673 | 66.017 |
| 25.772 | 63.789 | 24.241 | 66.603 |
| 23.637 | 64.943 | 21.815 | 67.140 |
| 21.467 | 66.069 | 19.393 | 67.632 |
| 19.259 | 67.164 | 16.974 | 68.078 |
| 17.011 | 68.229 | 14.556 | 68.479 |
| 14.722 | 69.263 | 12.138 | 68.835 |
| 12.390 | 70.266 | 9.718 | 69.148 |
| 10.012 | 71.238 | 7.296 | 69.418 |
| 7.586 | 72.177 | 6.896 | 69.458 |
| 5.110 | 73.082 | 2.436 | 69.757 |
| 2.582 | 73.953 | −0.743 | 69.796 |
| 0.000 | 74.787 | −2.436 | 69.767 |
| −1.312 | 75.189 | −4.873 | 69.689 |
| −6.502 | 74.918 | −7.312 | 69.568 |
| −7.803 | 74.239 | −9.754 | 69.403 |
| −10.246 | 72.906 | −12.201 | 69.193 |
| −12.617 | 71.553 | −14.653 | 68.939 |
| −14.917 | 70.180 | −17.114 | 68.639 |
| −17.151 | 68.790 | −19.583 | 68.292 |
| −19.321 | 67.382 | −22.062 | 67.899 |
| −21.431 | 65.957 | −24.552 | 67.457 |
| −23.482 | 64.518 | −27.055 | 66.965 |
| −25.479 | 63.062 | −29.573 | 66.421 |
| −27.423 | 61.592 | −32.105 | 65.825 |
| −29.316 | 60.108 | −34.654 | 65.175 |
| −31.162 | 58.608 | −37.220 | 64.468 |
| −32.963 | 57.093 | −39.805 | 63.702 |
| −34.720 | 55.563 | −42.410 | 62.875 |
| −36.435 | 54.018 | −45.035 | 61.985 |
| −38.111 | 52.456 | −46.911 | 61.312 |
| −39.750 | 50.877 | −50.972 | 57.980 |
| −41.352 | 49.281 | −51.389 | 57.074 |
| −42.920 | 47.667 | −52.556 | 54.423 |
| −44.454 | 46.034 | −53.645 | 51.805 |
| −45.957 | 44.381 | −54.662 | 49.218 |
| −47.430 | 42.706 | −55.609 | 46.662 |
| −48.981 | 40.882 | −56.491 | 44.136 |
| −50.275 | 39.279 | −57.310 | 41.638 |
| −51.700 | 37.383 | −58.069 | 39.168 |
| −52.907 | 35.687 | −58.772 | 36.725 |
| −54.171 | 33.850 | −59.420 | 34.306 |
| −55.406 | 31.989 | −60.016 | 31.911 |
| −56.614 | 30.102 | −60.563 | 29.539 |
| −57.796 | 28.189 | −61.062 | 27.186 |
| −58.951 | 26.247 | −61.514 | 24.853 |
| −60.080 | 24.274 | −61.922 | 22.538 |
| −61.184 | 22.269 | −62.287 | 20.238 |
| −62.262 | 20.230 | −62.611 | 17.953 |
| −63.316 | 18.155 | −62.893 | 15.681 |
| −64.343 | 16.043 | −63.136 | 13.420 |
| −65.345 | 13.889 | −63.341 | 11.169 |
| −66.321 | 11.694 | −63.507 | 8.925 |
| −67.270 | 9.454 | −63.635 | 6.688 |
| −68.191 | 7.167 | −63.727 | 4.456 |
| −69.085 | 4.831 | −63.782 | 2.227 |
| −69.949 | 2.443 | −63.800 | 0.000 |
| −70.783 | 0.000 | −63.761 | −2.227 |
| −71.584 | −2.500 | −63.645 | −4.450 |
| −72.352 | −5.059 | −63.471 | −6.671 |
| −73.085 | −7.681 | −63.261 | −8.891 |
| −73.779 | −10.369 | −63.014 | −11.111 |
| −74.433 | −13.125 | −62.729 | −13.334 |
| −75.043 | −15.951 | −62.407 | −15.560 |
| −75.276 | −17.130 | −62.046 | −17.791 |
| −73.940 | −22.197 | −61.646 | −20.030 |
| −72.920 | −23.693 | −61.206 | −22.277 |
| −71.316 | −25.957 | −60.724 | −24.534 |
| −69.691 | −28.157 | −60.199 | −26.802 |
| −68.046 | −30.296 | −59.631 | −29.084 |
| −66.382 | −32.376 | −59.016 | −31.380 |
| −64.698 | −34.401 | −58.355 | −33.691 |
| −62.996 | −36.371 | −57.644 | −36.020 |
| −61.276 | −38.289 | −56.882 | −38.368 |
| −59.537 | −40.158 | −56.067 | −40.735 |
| −57.779 | −41.979 | −55.196 | −43.124 |
| −56.002 | −43.753 | −54.266 | −45.534 |
| −54.205 | −45.483 | −53.275 | −47.969 |
| −52.388 | −47.171 | −52.219 | −50.427 |
| −50.551 | −48.817 | −51.096 | −52.911 |
| −48.692 | −50.422 | −49.901 | −55.421 |
| −46.812 | −51.990 | −49.167 | −56.900 |
| −44.908 | −53.519 | −45.110 | −60.168 |
| −42.981 | −55.013 | −43.992 | −60.549 |
| −41.499 | −56.124 | −41.408 | −61.391 |
| −39.032 | −57.867 | −38.848 | −62.170 |
| −35.100 | −60.333 | −36.310 | −62.891 |
| −34.900 | −60.449 | −33.793 | −63.555 |
| −32.781 | −61.652 | −31.295 | −64.164 |
| −30.638 | −62.818 | −28.816 | −64.721 |
| −28.471 | −63.948 | −26.353 | −65.227 |
| −26.279 | −65.042 | −23.907 | −65.684 |
| −24.059 | −66.100 | −21.475 | −66.093 |
| −21.810 | −67.124 | −19.056 | −66.456 |
| −19.531 | −68.111 | −16.649 | −66.774 |
| −17.220 | −69.064 | −14.251 | −67.048 |
| −14.875 | −69.981 | −11.863 | −67.278 |
| −12.495 | −70.862 | −9.482 | −67.466 |
| −10.078 | −71.706 | −7.106 | −67.611 |
| −7.621 | −72.514 | −4.735 | −67.715 |
| −6.291 | −72.929 | −2.367 | −67.778 |
| −0.575 | −73.198 | −0.071 | −67.800 |
| 0.000 | −73.012 | 2.366 | −67.759 |
| 2.520 | −72.163 | 4.729 | −67.635 |
| 4.984 | −71.281 | 7.358 | −67.400 |
| 7.396 | −70.367 | 9.438 | −67.156 |
| 9.757 | −69.422 | 11.786 | −66.842 |
| 12.069 | −68.447 | 14.132 | −66.487 |
| 14.336 | −67.444 | 16.478 | −66.091 |
| 16.558 | −66.412 | 18.825 | −65.652 |
| 18.739 | −65.352 | 21.175 | −65.170 |
| 20.881 | −64.265 | 23.528 | −64.643 |
| 22.985 | −63.151 | 25.887 | −64.072 |
| 25.053 | −62.009 | 28.252 | −63.455 |
| 27.088 | −60.840 | 30.625 | −62.791 |
| 29.090 | −59.644 | 33.007 | −62.078 |
| 31.062 | −58.419 | 35.400 | −61.314 |
| 33.005 | −57.167 | 37.804 | −60.499 |
| 34.921 | −55.886 | 40.220 | −59.629 |
| 36.811 | −54.575 | 42.650 | −58.703 |
| 38.677 | −53.234 | 45.095 | −57.719 |
| 39.028 | −52.976 | 47.555 | −56.674 |
| 42.295 | −50.406 | 50.031 | −55.565 |
| 44.589 | −48.389 | 52.524 | −54.390 |
| 45.715 | −47.339 | 55.034 | −53.146 |
| 47.374 | −45.748 | 57.563 | −51.830 |
| 49.008 | −44.127 | 61.888 | −49.422 |
| 50.619 | −42.475 | 63.085 | −47.884 |
| 52.208 | −40.789 | 63.506 | −46.140 |
| 53.774 | −39.069 | 64.146 | −43.267 |
| 55.319 | −37.313 | 64.717 | −40.439 |
| 56.844 | −35.520 | 65.220 | −37.655 |
| 58.348 | −33.687 | 65.660 | −34.912 |
| 59.833 | −31.814 | 66.039 | −32.209 |
| 61.298 | −29.897 | 66.360 | −29.546 |
| 62.743 | −27.935 | 66.627 | −26.919 |
| 64.169 | −25.926 | 66.841 | −24.328 |
| 65.576 | −23.868 | 67.005 | −21.771 |
| 66.963 | −21.757 | 67.121 | −19.247 |
| 68.329 | −19.593 | 67.190 | −16.752 |
| 69.675 | −17.372 | 67.214 | −14.287 |
| 70.999 | −15.091 | 67.195 | −11.848 |
| 72.301 | −12.749 | 67.133 | −9.435 |
| 73.578 | −10.341 | 67.031 | −7.045 |
| 74.831 | −7.865 | 66.888 | −4.677 |
| 76.056 | −5.318 | 66.706 | −2.329 |
| 77.253 | −2.698 | 66.485 | 0.000 |

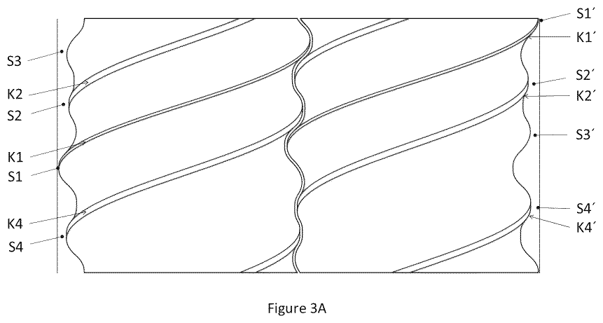

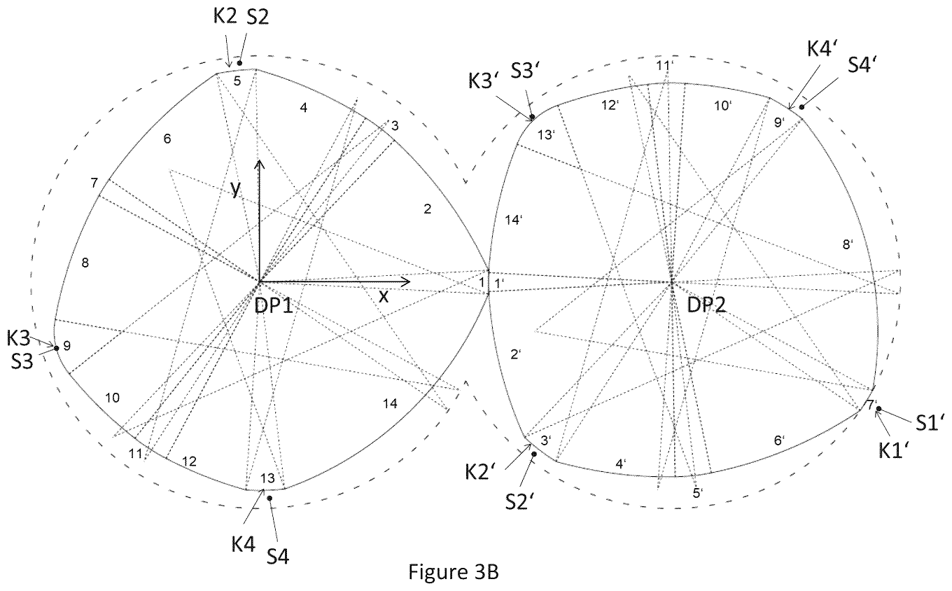

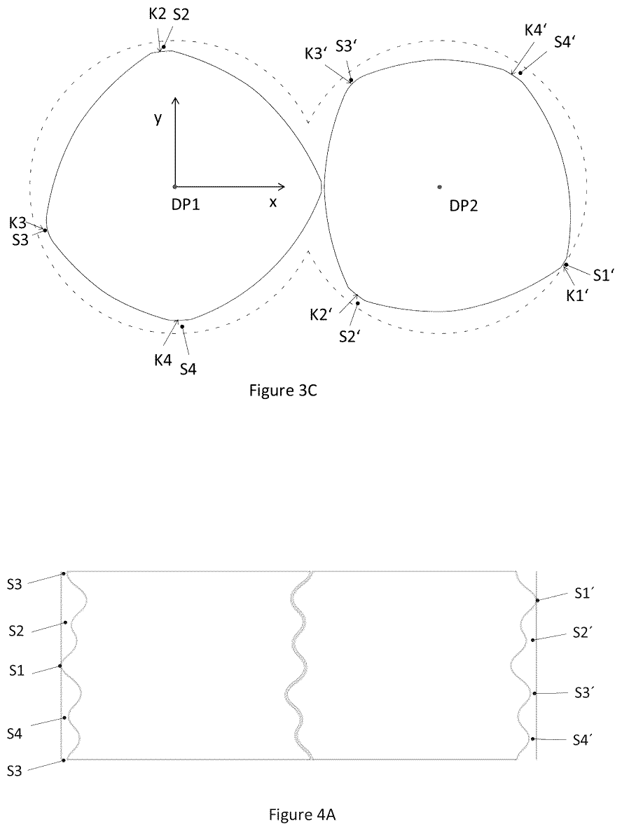

FIGS. 3A, 3B and 3C show a further pair of four-flight screw elements according to the invention, wherein this pair of screw elements is characterized in that the screw profile has no kinks at a crest, here crest 3 or crest 3′, the screw profile at crest 3 or crest 3′ is therefore continuously differentiable and the screw element therefore has no edges at this point. The ratio a/dg of center distance a to housing inner diameter dg is 0.9 here and is therefore less than 0.924.

FIG. 3A shows a plan view of the pair of four-flight screw elements as a pair of screw elements that practically clean each other. The housing wall is indicated by vertical lines in FIG. 3A. The crests K1, K2 and K4 and also K1′, K2′ and K4′ as well as the gaps S1 to S4 and S1′ to S4′ are marked in the figure. The crests K3 and K3′ cannot be seen in this illustration as they have no edges. 10 FIG. 3B shows a cross-section of the pair of four-flight screw elements. The pivot points of the two screw elements of the pair of screw elements are again labeled DP1 and DP2. The contour of the housing is shown by a dashed line. The circular arcs that make up the screw profiles are labeled with the numbers 1 to 14 for the left-hand screw profile and with the numbers 1′ to 14′ for the right-hand screw profile.

The gaps between the screw crests and the housing wall are labeled S1 to S4 for the left-hand screw element and S1′ to S4′ for the right-hand screw element. The gap S1 cannot be seen in the illustration in FIG. 1B because the left-hand screw element is cleaning the neighboring screw element in the position shown.

FIG. 3B shows the screw profile of two screw elements that clean each other precisely, i.e. there is no clearance between the screw elements when the screw elements clean each other. Similarly, the gap S1 or S1′ between the screw crest K1 or K1′ and the housing is zero.

FIG. 3C shows the screw cross-sectional profile from FIG. 3B, but with a gap during the mutual cleaning of the screw elements and during the cleaning of the housing wall by the crests K1 and K1′. The screw profiles of the screw elements were determined here using the spatial equidistant calculation rule. Alternatively, such screw profiles that practically clean each other can also be calculated using the longitudinal equidistant calculation rule.

According to a preferred embodiment of the invention, the screw profiles of the screw elements in FIG. 3B are composed only of circular arcs. The following table 3 lists the radii, the angles, the coordinates of the circle centers (MP) and the coordinates of the starting points (SP) of the respective circular arcs for the screw profiles in FIGS. 3A and 3B with the circular arcs 1 to 14 and 1′ to 14′. All length dimensions are normalized to the center distance a between the pivot points DP1 and DP2. The origin of the coordinates is located at the pivot point of the respective screw profile. The center angles-referred to here as angles for short—are given in radians.

TABLE 3B
Coordinates of the precisely cleaning screw profiles in FIG. 3B
Left shaft

| No. | Radius | Angle | S-point-x | S-point-y | M-point-x | M-point-y |
|---|---|---|---|---|---|---|
| 1 | 0.555556 | 0.104720 | 0.555556 | 0.000000 | 0.000000 | 0.000000 |
| 2 | 1.000000 | 0.394862 | 0.552512 | 0.058071 | −0.336916 | −0.399003 |
| 3 | 0.477778 | 0.185385 | 0.308243 | 0.365045 | 0.000000 | 0.000000 |
| 4 | 1.000000 | 0.292775 | 0.235674 | 0.415607 | −0.257597 | −0.454269 |
| 5 | 0.522222 | 0.185385 | −0.036371 | 0.520954 | 0.000000 | 0.000000 |
| 6 | 1.000000 | 0.369983 | −0.131773 | 0.505324 | 0.473374 | −0.290790 |
| 7 | 0.444444 | 0.104720 | −0.378699 | 0.232632 | 0.000000 | 0.000000 |
| 8 | 1.000000 | 0.323823 | −0.400941 | 0.191773 | 0.501177 | −0.239716 |
| 9 | 0.166667 | 0.850839 | −0.491351 | −0.117702 | −0.325930 | −0.138037 |
| 10 | 1.000000 | 0.224926 | −0.450290 | −0.248998 | 0.295870 | 0.416768 |
| 11 | 0.488889 | 0.185385 | −0.283006 | −0.398647 | 0.000000 | 0.000000 |
| 12 | 1.000000 | 0.208894 | −0.204676 | −0.443982 | 0.213980 | 0.464163 |
| 13 | 0.511111 | 0.185385 | −0.007246 | −0.511060 | 0.000000 | 0.000000 |
| 14 | 0.833333 | 0.850839 | 0.087080 | −0.503638 | −0.234466 | 0.265161 |

Right shaft

| | Radius | Angle | S-point-x | S-point-y | M-point-x | M-point-y |
|---|---|---|---|---|---|---|
| 1′ | 0.444444 | 0.104720 | −0.444444 | 0.000000 | 0.000000 | 0.000000 |
| 2′ | 1.000000 | 0.369983 | −0.442010 | −0.046457 | 0.552512 | 0.058071 |
| 3′ | 0.522222 | 0.185385 | −0.336916 | −0.399003 | 0.000000 | 0.000000 |
| 4′ | 1.000000 | 0.292775 | −0.257597 | −0.454269 | −0.036371 | 0.520954 |
| 5′ | 0.477778 | 0.185385 | 0.033276 | −0.476618 | 0.000000 | 0.000000 |
| 6′ | 1.000000 | 0.394862 | 0.120558 | −0.462317 | −0.131773 | 0.505324 |
| 7′ | 0.555556 | 0.104720 | 0.473374 | −0.290790 | 0.000000 | 0.000000 |
| 8′ | 0.833333 | 0.850839 | 0.501177 | −0.239716 | −0.325930 | −0.138037 |
| 9′ | 0.511111 | 0.185385 | 0.295870 | 0.416768 | 0.000000 | 0.000000 |
| 10′ | 1.000000 | 0.208894 | 0.213980 | 0.464163 | −0.007246 | −0.511060 |
| 11′ | 0.488889 | 0.185385 | 0.006931 | 0.488840 | 0.000000 | 0.000000 |
| 12′ | 1.000000 | 0.224926 | −0.083294 | 0.481741 | 0.087080 | −0.503638 |
| 13′ | 0.166667 | 0.850839 | −0.298775 | 0.418921 | −0.234466 | 0.265161 |
| 14′ | 1.000000 | 0.323823 | −0.392470 | 0.318193 | 0.555556 | 0.000000 |

TABLE 3C
Cartesian coordinates of the practically cleaning screw profiles
in FIG. 2C, read off in 2° steps in a mathematically positive
directional sense, in millimeters [mm], for screw elements for
a twin-screw extruder with a housing inner diameter of 100 mm and
a center distance of 90 mm. The pitch of the screw elements is 100
mm, the clearance between the screw elements is 1 mm, the gap between
the screw elements and the housing is 0.5 mm. The pitch is 100 mm.

| | |
|---|---|
| Left shaft | Right shaft |

| x (mm) | y (mm) | x (mm) | y (mm) |
|---|---|---|---|
| 49.260 | 0.000 | 44.073 | 0.000 |
| 49.495 | 0.726 | 43.806 | 1.530 |
| 49.306 | 4.383 | 43.509 | 3.042 |
| 48.928 | 5.143 | 43.182 | 4.539 |
| 48.093 | 6.759 | 42.826 | 6.019 |
| 47.240 | 8.330 | 42.441 | 7.483 |
| 46.372 | 9.857 | 42.028 | 8.933 |
| 45.487 | 11.341 | 41.586 | 10.369 |
| 44.588 | 12.786 | 41.117 | 11.790 |
| 43.676 | 14.191 | 40.619 | 13.198 |
| 42.750 | 15.560 | 40.094 | 14.593 |
| 41.811 | 16.893 | 39.541 | 15.976 |
| 40.859 | 18.192 | 38.960 | 17.346 |
| 39.895 | 19.458 | 38.351 | 18.705 |
| 38.919 | 20.694 | 37.713 | 20.052 |
| 37.931 | 21.899 | 37.046 | 21.389 |
| 36.930 | 23.076 | 36.351 | 22.714 |
| 35.916 | 24.226 | 35.625 | 24.030 |
| 34.890 | 25.349 | 34.870 | 25.335 |
| 33.851 | 26.447 | 34.085 | 26.630 |
| 32.798 | 27.521 | 33.268 | 27.915 |
| 31.732 | 28.572 | 32.419 | 29.190 |
| 30.651 | 29.600 | 31.538 | 30.456 |
| 29.556 | 30.606 | 30.624 | 31.712 |
| 28.445 | 31.592 | 29.676 | 32.958 |
| 27.415 | 32.476 | 28.692 | 34.194 |
| 26.166 | 33.490 | 27.673 | 35.420 |
| 24.981 | 34.383 | 26.617 | 36.635 |
| 23.766 | 35.234 | 25.948 | 37.376 |
| 22.522 | 36.042 | 24.111 | 38.586 |
| 20.973 | 36.965 | 22.750 | 39.404 |
| 19.956 | 37.532 | 21.361 | 40.174 |
| 18.649 | 38.236 | 19.452 | 41.132 |
| 17.327 | 38.918 | 18.420 | 41.373 |
| 15.991 | 39.578 | 16.853 | 41.712 |
| 14.638 | 40.217 | 15.294 | 42.020 |
| 13.268 | 40.836 | 13.743 | 42.297 |
| 11.881 | 41.433 | 12.199 | 42.544 |
| 10.474 | 42.009 | 10.662 | 42.762 |
| 9.047 | 42.564 | 9.129 | 42.951 |
| 7.599 | 43.099 | 7.602 | 43.111 |
| 6.129 | 43.611 | 6.078 | 43.244 |
| 4.635 | 44.102 | 4.556 | 43.349 |
| 3.117 | 44.571 | 3.037 | 43.427 |
| 1.572 | 45.016 | 1.518 | 43.478 |
| 0.000 | 45.438 | 0.607 | 43.496 |
| −1.601 | 45.836 | −1.518 | 43.474 |
| −3.231 | 46.209 | −3.034 | 43.394 |
| −3.851 | 46.340 | −4.547 | 43.262 |
| −6.472 | 46.047 | −6.054 | 43.077 |
| −8.075 | 45.794 | −7.404 | 42.865 |
| −10.997 | 45.181 | −9.047 | 42.565 |
| −11.224 | 45.016 | −10.537 | 42.263 |
| −12.609 | 43.973 | −12.025 | 41.935 |
| −13.947 | 42.925 | −13.510 | 41.580 |
| −15.240 | 41.872 | −14.994 | 41.196 |
| −16.490 | 40.814 | −16.478 | 40.784 |
| −17.699 | 39.752 | −17.962 | 40.344 |
| −18.868 | 38.686 | −19.448 | 39.873 |
| −20.001 | 37.616 | −20.935 | 39.373 |
| −21.098 | 36.542 | −22.425 | 38.841 |
| −22.161 | 35.465 | −23.918 | 38.277 |
| −23.191 | 34.383 | −25.415 | 37.679 |
| −24.191 | 33.297 | −26.916 | 37.047 |
| −25.162 | 32.206 | −28.396 | 36.345 |
| −26.104 | 31.110 | −29.770 | 35.478 |
| −27.020 | 30.009 | −31.015 | 34.445 |
| −27.910 | 28.901 | −32.117 | 33.258 |
| −28.775 | 27.787 | −33.066 | 31.931 |
| −29.616 | 26.667 | −33.854 | 30.482 |
| −30.435 | 25.538 | −34.476 | 28.929 |
| −31.232 | 24.401 | −35.018 | 27.359 |
| −32.008 | 23.255 | −35.521 | 25.807 |
| −32.763 | 22.099 | −35.987 | 24.273 |
| −33.498 | 20.932 | −36.418 | 22.756 |
| −33.661 | 20.668 | −36.816 | 21.255 |
| −34.876 | 18.544 | −37.181 | 19.770 |
| −35.631 | 17.049 | −37.516 | 18.298 |
| −36.092 | 16.069 | −37.822 | 16.839 |
| −36.662 | 14.812 | −38.099 | 15.393 |
| −37.212 | 13.544 | −38.349 | 13.958 |
| −37.742 | 12.263 | −38.573 | 12.533 |
| −38.254 | 10.969 | −38.771 | 11.117 |
| −38.747 | 9.661 | −38.944 | 9.710 |
| −39.221 | 8.337 | −39.093 | 8.310 |
| −39.676 | 6.996 | −39.218 | 6.915 |
| −40.112 | 5.637 | −39.320 | 5.526 |
| −40.530 | 4.260 | −39.399 | 4.141 |
| −40.928 | 2.862 | −39.455 | 2.759 |
| −41.306 | 1.442 | −39.489 | 1.379 |
| −41.664 | 0.000 | −39.500 | 0.000 |
| −42.001 | −1.467 | −39.476 | −1.379 |
| −42.317 | −2.959 | −39.404 | −2.755 |
| −42.611 | −4.479 | −39.284 | −4.129 |
| −42.882 | −6.027 | −39.128 | −5.499 |
| −43.129 | −7.605 | −38.951 | −6.868 |
| −43.350 | −9.214 | −38.750 | −8.237 |
| −43.545 | −10.857 | −38.527 | −9.606 |
| −43.686 | −12.527 | −38.281 | −10.977 |
| −43.643 | −14.181 | −38.011 | −12.350 |
| −43.403 | −15.797 | −37.716 | −13.728 |
| −42.964 | −17.359 | −37.397 | −15.109 |
| −42.329 | −18.846 | −37.052 | −16.496 |
| −41.504 | −20.243 | −36.680 | −17.890 |
| −40.503 | −21.536 | −36.282 | −19.291 |
| −39.423 | −22.761 | −35.855 | −20.701 |
| −38.333 | −23.953 | −35.398 | −22.119 |
| −37.232 | −25.113 | −34.911 | −23.548 |
| −36.120 | −26.242 | −34.392 | −24.987 |
| −34.996 | −27.342 | −33.840 | −26.438 |
| −33.862 | −28.413 | −33.252 | −27.902 |
| −32.716 | −29.457 | −32.628 | −29.379 |
| −31.557 | −30.475 | −31.966 | −30.869 |
| −30.387 | −31.466 | −31.263 | −32.374 |
| −29.203 | −32.433 | −30.518 | −33.894 |
| −28.006 | −33.376 | −29.728 | −35.429 |
| −26.795 | −34.296 | −29.415 | −36.014 |
| −25.174 | −35.476 | −27.332 | −37.619 |
| −24.325 | −36.063 | −26.002 | −38.550 |
| −23.051 | −36.890 | −24.641 | −39.434 |
| −21.750 | −37.672 | −23.468 | −40.144 |
| −20.422 | −38.408 | −21.578 | −40.582 |
| −18.219 | −39.501 | −19.959 | −40.921 |
| −17.694 | −39.741 | −18.355 | −41.226 |
| −16.305 | −40.355 | −16.766 | −41.498 |
| −14.903 | −40.946 | −15.191 | −41.737 |
| −13.488 | −41.513 | −13.629 | −41.945 |
| −12.059 | −42.056 | −12.079 | −42.124 |
| −10.615 | −42.575 | −10.540 | −42.273 |
| −9.155 | −43.071 | −9.011 | −42.394 |
| −7.678 | −43.543 | −7.492 | −42.487 |
| −6.183 | −43.992 | −5.980 | −42.553 |
| −4.668 | −44.417 | −4.477 | −42.592 |
| −3.134 | −44.817 | −2.979 | −42.605 |
| −1.578 | −45.192 | −1.487 | −42.591 |
| −0.199 | −45.500 | 0.000 | −42.552 |
| 1.588 | −45.472 | 1.484 | −42.487 |
| 3.174 | −45.389 | 2.965 | −42.396 |
| 4.756 | −45.251 | 4.442 | −42.267 |
| 7.282 | −44.913 | 5.915 | −42.086 |
| 7.877 | −44.670 | 7.380 | −41.854 |
| 9.360 | −44.036 | 8.836 | −41.571 |
| 10.815 | −43.375 | 10.713 | −41.128 |
| 12.241 | −42.690 | 11.716 | −40.860 |
| 13.640 | −41.980 | 13.145 | −40.455 |
| 15.013 | −41.247 | 14.568 | −40.026 |
| 16.359 | −40.491 | 15.987 | −39.570 |
| 17.681 | −39.711 | 17.403 | −39.089 |
| 18.977 | −38.909 | 18.817 | −38.580 |
| 20.250 | −38.085 | 20.228 | −38.044 |
| 21.499 | −37.238 | 21.639 | −37.480 |
| 22.726 | −36.369 | 23.049 | −36.886 |
| 23.930 | −35.478 | 24.460 | −36.263 |
| 25.113 | −34.565 | 25.871 | −35.609 |
| 26.274 | −33.630 | 27.285 | −34.923 |
| 27.415 | −32.672 | 28.700 | −34.204 |
| 28.535 | −31.691 | 30.118 | −33.450 |
| 29.635 | −30.688 | 31.540 | −32.660 |
| 30.715 | −29.661 | 32.965 | −31.834 |
| 31.775 | −28.611 | 34.394 | −30.968 |
| 32.816 | −27.536 | 35.827 | −30.062 |
| 33.838 | −26.437 | 37.264 | −29.114 |
| 34.841 | −25.313 | 38.706 | −28.122 |
| 35.824 | −24.164 | 40.152 | −27.083 |
| 36.788 | −22.988 | 41.602 | −25.996 |
| 37.733 | −21.785 | 42.589 | −25.227 |
| 38.658 | −20.555 | 43.706 | −23.239 |
| 39.564 | −19.296 | 44.338 | −22.009 |
| 40.449 | −18.009 | 44.604 | −19.859 |
| 41.314 | −16.692 | 44.775 | −18.090 |
| 42.158 | −15.344 | 44.902 | −16.343 |
| 42.980 | −13.965 | 44.986 | −14.617 |
| 43.780 | −12.554 | 45.030 | −12.912 |
| 44.557 | −11.109 | 45.035 | −11.228 |
| 45.310 | −9.631 | 45.001 | −9.565 |
| 46.038 | −8.118 | 44.932 | −7.923 |
| 46.740 | −6.569 | 44.826 | −6.300 |
| 47.414 | −4.983 | 44.687 | −4.697 |
| 48.060 | −3.361 | 44.514 | −3.113 |
| 48.676 | −1.700 | 44.310 | −1.547 |
| 49.260 | 0.000 | 44.073 | 0.000 |

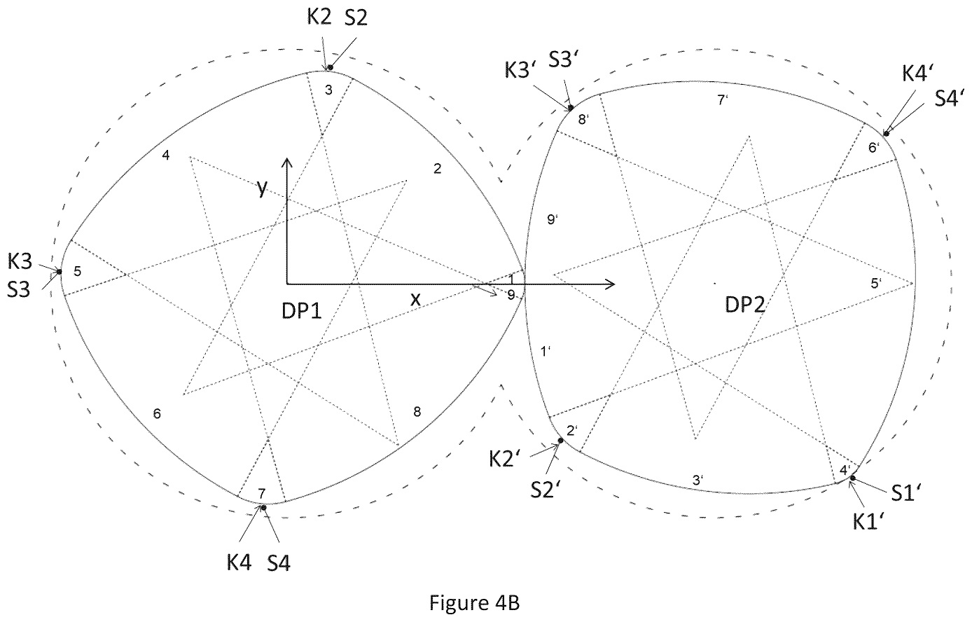

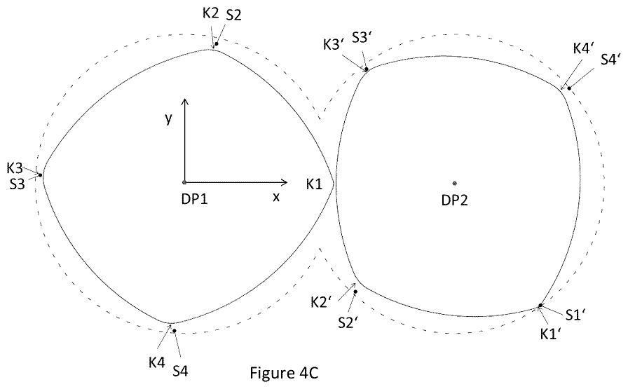

FIGS. 4A, 4B and 4C show another pair of four-flight screw elements according to the invention, which is characterized by the fact that it has no kinks at all four crests, i.e., the screw profile is continuously differentiable at all crests and thus has no edges. The ratio a/dg of center distance a to housing inner diameter dg is 0.9023 here and is therefore less than 0.924.

FIG. 4A shows a plan view of the pair of four-flight screw elements as a pair of screw elements that practically clean each other. The housing wall is indicated by vertical lines in FIG. 4A. The gaps S1 to S4 and S1′ to S4′ are marked in the figure. The crests are not visible as the screw element has no edges.

FIG. 4B shows the screw profiles of the precisely scraping screw elements on which the practically cleaning screw elements shown in FIGS. 4A and 4C are based. The pivot points of the two screw elements of the pair of screw elements are again labeled DP1 and DP2. The contour of the housing is shown by a dashed line. The circular arcs that make up the screw profile are labeled with the numbers 1 to 9 for the left-hand screw profile and with the numbers 1′ to 9′ for the right-hand screw profile. The gaps between the screw crests and the housing wall are labeled S1 to S4 for the left-hand screw element and S1′ to S4′ for the right-hand screw element. The gap S1 cannot be seen in the illustration in FIG. 1B because the left-hand screw element is cleaning the neighboring screw element in the position shown.

FIG. 4C shows the screw cross-sectional profile of the practically cleaning screw elements from FIG. 4A. The screw cross-sectional profiles of the screw elements were determined here using the spatial equidistant calculation rule. Alternatively, such screw profiles that practically clean each other can also be calculated using the longitudinal equidistant calculation rule.

According to a preferred embodiment of the invention, the screw profiles of the screw elements in FIG. 4B are composed only of circular arcs. The following table 4B lists the radii, the angles, the coordinates of the circle centers (MP) and the coordinates of the starting points (SP) of the respective circular arcs for the screw profile in FIG. 4B with the circular arcs 1 to 9 and 1′ to 9′. All length dimensions are normalized to the center distance a between the pivot points DP1 and DP2. The origin of the coordinates is located at the pivot point of the respective screw profile. The center angles-referred to here as angles for short—are given in radians.

Left shaft

| No. | Radius | Angle | S-point-x | S-point-y | M-point-x | M-point-y |
|---|---|---|---|---|---|---|
| 1 | 0.091969 | 0.765575 | 0.548137 | −0.036591 | 0.463761 | 0.000000 |
| 2 | 0.846719 | 0.727147 | 0.549950 | 0.032087 | −0.243563 | −0.263328 |
| 3 | 0.153281 | 0.727147 | 0.152876 | 0.484850 | 0.081109 | 0.349408 |
| 4 | 0.908031 | 0.765574 | 0.044690 | 0.498299 | 0.260432 | −0.383730 |
| 5 | 0.153281 | 0.893822 | −0.506318 | 0.102700 | −0.376886 | 0.020588 |
| 6 | 0.846719 | 0.755050 | −0.521972 | −0.028862 | 0.279475 | 0.244299 |
| 7 | 0.153281 | 0.755050 | −0.116964 | −0.503878 | −0.045197 | −0.368436 |
| 8 | 0.846719 | 0.893822 | −0.004639 | −0.516254 | −0.228682 | 0.300286 |

Right shaft

| Right | Radius | Angle | S-point-x | S-point-y | M-point-x | M-point-y |
|---|---|---|---|---|---|---|
| 1′ | 0.908031 | 0.765575 | −0.369309 | 0.361271 | 0.463761 | 0.000000 |
| 2′ | 0.153281 | 0.727147 | −0.387212 | −0.316806 | −0.243563 | −0.263328 |
| 3′ | 0.846719 | 0.727147 | −0.315330 | −0.398770 | 0.081109 | 0.349408 |
| 4′ | 0.091969 | 0.765574 | 0.282283 | −0.473065 | 0.260432 | −0.383730 |
| 5′ | 0.846719 | 0.893822 | 0.338091 | −0.432998 | −0.376886 | 0.020588 |
| 6′ | 0.153281 | 0.755050 | 0.424560 | 0.293749 | 0.279475 | 0.244299 |
| 7′ | 0.846719 | 0.755050 | 0.351242 | 0.379741 | −0.045197 | −0.368436 |
| 8′ | 0.153281 | 0.893822 | −0.269240 | 0.448104 | −0.228682 | 0.300286 |

The screw cross-sectional contour with spatial equidistant gap shown in FIG. 4C is given in the following table 4C in Cartesian coordinates for the left and right shafts. The coordinate origin for each of the two shafts is at the pivot point DP1 or DP2 of the respective screw element. The pair of four-flight screw elements has an outer diameter of 52.9 mm and is intended for installation in a housing with a center distance of 48 mm and a housing inner diameter dg of 53.2 mm. The clearance for mutual cleaning of the screw elements is 0.45 mm. The pitch is 40 mm.

| | |
|---|---|
| Left shaft | Right shaft |

| x (mm) | y (mm) | x (mm) | y (mm) |
|---|---|---|---|
| 26.450 | 0.000 | 22.314 | 0.000 |
| 26.245 | 0.917 | 22.324 | 0.780 |
| 25.923 | 1.813 | 22.319 | 1.561 |
| 25.585 | 2.689 | 22.298 | 2.344 |
| 25.231 | 3.546 | 22.260 | 3.129 |
| 24.863 | 4.384 | 22.207 | 3.916 |
| 24.480 | 5.203 | 22.138 | 4.706 |
| 24.083 | 6.005 | 22.052 | 5.498 |
| 23.673 | 6.788 | 21.949 | 6.294 |
| 23.250 | 7.554 | 21.829 | 7.093 |
| 22.815 | 8.304 | 21.692 | 7.895 |
| 22.367 | 9.037 | 21.536 | 8.701 |
| 21.908 | 9.754 | 21.363 | 9.511 |
| 21.437 | 10.456 | 21.170 | 10.325 |
| 20.955 | 11.142 | 20.958 | 11.144 |
| 20.462 | 11.814 | 20.726 | 11.966 |
| 19.957 | 12.471 | 20.473 | 12.793 |
| 19.442 | 13.114 | 20.200 | 13.625 |
| 18.915 | 13.743 | 19.903 | 14.461 |
| 18.378 | 14.358 | 19.553 | 15.277 |
| 17.830 | 14.961 | 19.098 | 16.025 |
| 17.270 | 15.550 | 18.534 | 16.688 |
| 16.699 | 16.126 | 17.867 | 17.254 |
| 16.118 | 16.690 | 17.118 | 17.726 |
| 15.524 | 17.242 | 16.341 | 18.148 |
| 14.920 | 17.781 | 15.564 | 18.548 |
| 14.303 | 18.307 | 14.788 | 18.927 |
| 13.675 | 18.822 | 14.012 | 19.286 |
| 13.035 | 19.325 | 13.236 | 19.624 |
| 12.382 | 19.815 | 12.461 | 19.942 |
| 11.717 | 20.294 | 11.686 | 20.241 |
| 11.039 | 20.761 | 10.912 | 20.522 |
| 10.347 | 21.215 | 10.137 | 20.784 |
| 9.643 | 21.658 | 9.363 | 21.029 |
| 8.924 | 22.088 | 8.588 | 21.257 |
| 8.191 | 22.505 | 7.813 | 21.467 |
| 7.444 | 22.910 | 7.038 | 21.660 |
| 6.682 | 23.302 | 6.262 | 21.837 |
| 5.888 | 23.616 | 5.485 | 21.997 |
| 5.060 | 23.803 | 4.706 | 22.141 |
| 4.208 | 23.862 | 3.927 | 22.269 |
| 3.345 | 23.802 | 3.146 | 22.382 |
| 2.484 | 23.636 | 2.362 | 22.478 |
| 1.639 | 23.437 | 1.577 | 22.558 |
| 0.811 | 23.225 | 0.790 | 22.622 |
| 0.000 | 22.999 | 0.000 | 22.670 |
| −0.795 | 22.762 | −0.793 | 22.703 |
| −1.574 | 22.512 | −1.589 | 22.719 |
| −2.339 | 22.251 | −2.388 | 22.719 |
| −3.089 | 21.978 | −3.191 | 22.702 |
| −3.825 | 21.695 | −3.997 | 22.669 |
| −4.549 | 21.402 | −4.808 | 22.619 |
| −5.260 | 21.097 | −5.623 | 22.551 |
| −5.959 | 20.783 | −6.442 | 22.466 |
| −6.647 | 20.458 | −7.266 | 22.363 |
| −7.324 | 20.123 | −8.095 | 22.242 |
| −7.991 | 19.778 | −8.930 | 22.101 |
| −8.648 | 19.423 | −9.769 | 21.942 |
| −9.295 | 19.058 | −10.614 | 21.762 |
| −9.934 | 18.682 | −11.464 | 21.561 |
| −10.564 | 18.297 | −12.320 | 21.339 |
| −11.185 | 17.900 | −13.182 | 21.095 |
| −11.799 | 17.493 | −14.034 | 20.806 |
| −12.405 | 17.075 | −14.827 | 20.408 |
| −13.005 | 16.645 | −15.541 | 19.891 |
| −13.597 | 16.204 | −16.162 | 19.262 |
| −14.183 | 15.752 | −16.692 | 18.538 |
| −14.762 | 15.287 | −17.127 | 17.736 |
| −15.336 | 14.810 | −17.504 | 16.904 |
| −15.903 | 14.320 | −17.858 | 16.079 |
| −16.466 | 13.816 | −18.188 | 15.262 |
| −17.022 | 13.299 | −18.497 | 14.451 |
| −17.574 | 12.768 | −18.784 | 13.647 |
| −18.120 | 12.222 | −19.052 | 12.850 |
| −18.661 | 11.661 | −19.300 | 12.060 |
| −19.197 | 11.083 | −19.529 | 11.275 |
| −19.728 | 10.489 | −19.741 | 10.497 |
| −20.254 | 9.878 | −19.936 | 9.723 |
| −20.774 | 9.249 | −20.114 | 8.955 |
| −21.290 | 8.602 | −20.276 | 8.192 |
| −21.799 | 7.934 | −20.422 | 7.433 |
| −22.303 | 7.247 | −20.553 | 6.678 |
| −22.801 | 6.538 | −20.670 | 5.927 |
| −23.293 | 5.808 | −20.772 | 5.179 |
| −23.777 | 5.054 | −20.859 | 4.434 |
| −24.254 | 4.277 | −20.933 | 3.691 |
| −24.683 | 3.469 | −20.994 | 2.950 |
| −24.994 | 2.627 | −21.040 | 2.211 |
| −25.177 | 1.761 | −21.073 | 1.474 |
| −25.216 | 0.881 | −21.093 | 0.737 |
| −25.111 | 0.000 | −21.100 | 0.000 |
| −24.880 | −0.869 | −21.093 | −0.737 |
| −24.599 | −1.720 | −21.073 | −1.474 |
| −24.303 | −2.554 | −21.040 | −2.211 |
| −23.993 | −3.372 | −20.994 | −2.950 |
| −23.668 | −4.173 | −20.933 | −3.691 |
| −23.330 | −4.959 | −20.859 | −4.434 |
| −22.979 | −5.729 | −20.772 | −5.179 |
| −22.615 | −6.485 | −20.670 | −5.927 |
| −22.238 | −7.226 | −20.553 | −6.678 |
| −21.850 | −7.953 | −20.422 | −7.433 |
| −21.449 | −8.666 | −20.276 | −8.192 |
| −21.036 | −9.366 | −20.114 | −8.955 |
| −20.612 | −10.053 | −19.936 | −9.723 |
| −20.176 | −10.728 | −19.741 | −10.497 |
| −19.728 | −11.390 | −19.529 | −11.275 |
| −19.268 | −12.040 | −19.300 | −12.060 |
| −18.797 | −12.679 | −19.052 | −12.850 |
| −18.315 | −13.306 | −18.784 | −13.647 |
| −17.820 | −13.923 | −18.497 | −14.451 |
| −17.314 | −14.528 | −18.188 | −15.262 |
| −16.796 | −15.123 | −17.848 | −16.070 |
| −16.265 | −15.707 | −17.421 | −16.823 |
| −15.723 | −16.281 | −16.901 | −17.502 |
| −15.167 | −16.845 | −16.288 | −18.090 |
| −14.599 | −17.399 | −15.589 | −18.578 |
| −14.018 | −17.943 | −14.838 | −18.992 |
| −13.424 | −18.477 | −14.084 | −19.385 |
| −12.816 | −19.001 | −13.327 | −19.758 |
| −12.194 | −19.515 | −12.568 | −20.113 |
| −11.558 | −20.019 | −11.806 | −20.449 |
| −10.907 | −20.513 | −11.042 | −20.767 |
| −10.241 | −20.997 | −10.275 | −21.067 |
| −9.559 | −21.471 | −9.506 | −21.351 |
| −8.862 | −21.934 | −8.734 | −21.616 |
| −8.148 | −22.387 | −7.958 | −21.865 |
| −7.418 | −22.829 | −7.180 | −22.098 |
| −6.670 | −23.260 | −6.398 | −22.313 |
| −5.904 | −23.678 | −5.613 | −22.512 |
| −5.119 | −24.085 | −4.824 | −22.695 |
| −4.311 | −24.449 | −4.031 | −22.861 |
| −3.470 | −24.693 | −3.234 | −23.011 |
| −2.607 | −24.799 | −2.433 | −23.144 |
| −1.732 | −24.766 | −1.627 | −23.261 |
| −0.859 | −24.607 | −0.816 | −23.361 |
| 0.000 | −24.384 | 0.000 | −23.445 |
| 0.843 | −24.145 | 0.821 | −23.512 |
| 1.671 | −23.891 | 1.648 | −23.561 |
| 2.483 | −23.622 | 2.480 | −23.594 |
| 3.280 | −23.339 | 3.318 | −23.609 |
| 4.063 | −23.042 | 4.162 | −23.606 |
| 4.832 | −22.732 | 5.013 | −23.585 |
| 5.587 | −22.409 | 5.870 | −23.545 |
| 6.329 | −22.073 | 6.734 | −23.486 |
| 7.059 | −21.725 | 7.605 | −23.407 |
| 7.776 | −21.364 | 8.483 | −23.308 |
| 8.481 | −20.991 | 9.369 | −23.188 |
| 9.174 | −20.606 | 10.261 | −23.047 |
| 9.857 | −20.209 | 11.161 | −22.883 |
| 10.528 | −19.800 | 12.068 | −22.697 |
| 11.188 | −19.379 | 12.982 | −22.486 |
| 11.839 | −18.946 | 13.904 | −22.251 |
| 12.479 | −18.500 | 14.789 | −21.926 |
| 13.109 | −18.043 | 15.449 | −21.264 |
| 13.730 | −17.573 | 15.984 | −20.459 |
| 14.341 | −17.091 | 16.491 | −19.653 |
| 14.943 | −16.596 | 16.971 | −18.848 |
| 15.536 | −16.088 | 17.425 | −18.044 |
| 16.120 | −15.567 | 17.854 | −17.242 |
| 16.695 | −15.033 | 18.260 | −16.441 |
| 17.262 | −14.485 | 18.642 | −15.643 |
| 17.820 | −13.923 | 19.003 | −14.846 |
| 18.370 | −13.346 | 19.341 | −14.052 |
| 18.911 | −12.755 | 19.659 | −13.260 |
| 19.443 | −12.149 | 19.956 | −12.470 |
| 19.966 | −11.528 | 20.234 | −11.682 |
| 20.481 | −10.890 | 20.492 | −10.896 |
| 20.987 | −10.236 | 20.732 | −10.112 |
| 21.484 | −9.565 | 20.954 | −9.329 |
| 21.972 | −8.877 | 21.158 | −8.548 |
| 22.450 | −8.171 | 21.344 | −7.769 |
| 22.918 | −7.446 | 21.514 | −6.990 |
| 23.375 | −6.703 | 21.667 | −6.213 |
| 23.822 | −5.940 | 21.804 | −5.436 |
| 24.258 | −5.156 | 21.924 | −4.660 |
| 24.681 | −4.352 | 22.028 | −3.884 |
| 25.092 | −3.527 | 22.117 | −3.108 |
| 25.490 | −2.679 | 22.190 | −2.332 |
| 25.874 | −1.809 | 22.247 | −1.556 |
| 26.242 | −0.916 | 22.288 | −0.778 |
| 26.450 | 0.000 | 22.314 | 0.000 |

1. A pair of four-flight screw elements, suitable for a multishaft screw machine comprising:
m screw shafts SW1 to SWm rotating in the same direction and at the same speed, the respective neighboring axes of rotation D1 to Dm of which have a center distance a in a cross-section at right angles to the axes of rotation; and
m circular housing bores which penetrate one another, each of which has an identical housing inner radius rg and the bore centers M1 to Mm of which are at a distance which is the same as the center distance a, and the bore centers M1 to Mm of which coincide with the respective associated axes of rotation D1 to Dm of the screw shafts SW1 to SWm,
wherein each of the two screw elements of the pair of four-flight screw elements has a screw profile comprising:
(1) a closed convex curve, wherein this closed convex curve is composed merely of curve sections of which the radii of curvature are less than or equal to the center distance a,
(2) at least 16 curves,
(3) exactly one or no axis symmetry,
(4) exactly four grooves,
(5) exactly four crests-labeled as they revolve as K1, K2, K3 and K4,
(6) a crest radius r(Ki) respectively associated with a crest Ki is the greatest distance of a crest Ki from the pivot point DPm, wherein the following is true:
(K1)>r(K2) and r(K1)>r(K3) and r(K1)>r(K4), and
r(K3)>r(K2) and r(K3)>r(K4),
wherein r(K1) is the crest radius of the screw crest K1 and r(K2) is the crest radius of the screw crest K2 and r(K3) is the crest radius of the screw crest K3, and r(K4) is the crest radius of the screw crest K4,
wherein r(K1) is equal to the outer radius ra,
wherein the outer radius ra is the radius of the circle which encloses the entire screw profile and of which the center point is the pivot point associated with this screw profile, wherein the crest K1 is a segment of this circle,
wherein m is an integer greater than 1, and
wherein i may assume the values 1, 2, 3 or 4,
(7) two screw elements located oppositely in pairs and directly adjacently to one another on two of the screw shafts of the multishaft screw machine, which rotate in the same direction and at the same speed, practically clean one another in pairs,
(8) a groove is separated from the nearest point of a neighboring crest by a flank,
(9) it has exactly eight curves, which are flanks.

2. The pair of four-flight screw elements as claimed in claim 1, wherein:
each of the four crests is formed from only one curve section each, which is a circular arc of which the center point is the pivot point common to the four crests, and the two curve sections immediately neighboring a crest have a smaller distance from the pivot point than the circular arc of this crest, except for the common point of contact, and
each of the four grooves is formed from only one curve section, which is a circular arc of which the center point is the pivot point common to the four grooves, and the two curve sections directly neighboring a groove are at a greater distance from the pivot point than the circular arc of this groove, except for the common point of contact, and wherein there is exactly one groove of which the distance from the pivot point is smaller than the distances of the other grooves from the pivot point.

3. The pair of four-flight screw elements as claimed in claim 2, wherein the screw crest with the greatest distance r(Ki) of the screw crest from the pivot point has the smallest crest angle.

4. The pair of four-flight screw elements as claimed in claim 1, wherein the crest angle of the crest K1 is not equal to the crest angle of the crest K3 and the crest angle of the crest K2 is not equal to the crest angle of the crest K4.

5. The pair of four-flight screw elements as claimed in claim 1, wherein all crest angles of the crests K1, K2, K3 and K4 are different from one another.

6. The pair of four-flight screw elements as claimed in claim 1, wherein, for a given housing inner radius rg in relation to a given center distance a, the distance r(K1) of the crest K1 from the pivot point is selected such that the following range applies for r(K1):r(K1) is less than or equal to rg−0.001*a and r(K1) is greater than or equal to rg−0.015*a.

7. The pair of four-flight screw elements as claimed in claim 1, wherein, for a given housing inner radius rg in relation to a given center distance a, the following applies for the distance r(K3) of the crest K3 from the pivot point: r(K3) is less than or equal to r(K1)−0.0015*a and r(K3) is less than or greater than r(K1)−0.03*a.

8. The pair of four-flight screw elements as claimed in claim 7, wherein, for a given housing inner radius rg in relation to a given center distance a, the following applies for the distance r(K2) of the crest K2 from the pivot point: r(K2) is less than or equal to r(K1)−0.003*a and r(K2) is greater than or equal to r(K1)−0.08*a.

9. The pair of four-flight screw elements as claimed in one of claim 6, wherein, for a given housing inner radius rg in relation to a given center distance a, the distance r(K4) of the crest K4 from the pivot point is selected such that the following range applies for r(K4): r(K4) is less than or equal to r(K1)−0.003*a and r(K4) is greater than or equal to r(K1)−0.08*a.

10. The pair of four-flight screw elements as claimed in claim 2, wherein the crest angle KW1 is from greater than 0 degrees to less than 8 degrees.

11. The pair of four-flight screw elements as claimed in claim 1, wherein the crest angle KW1 is 0 degrees.

12. The pair of four-flight screw elements as claimed in claim 1, wherein all screw elements practically clean each other in a cross-section at right angles to the screw shafts SW1 to SWm.

13. A multishaft screw machine comprising the pair of four-flight screw elements as claimed in claim 1.

14. A method comprising extruding plastic or viscoelastic masses using the pair of four-flight screw elements as claimed in claim 1.

15. A method comprising compounding thermoplastics with colorants and additives using the pair of four-flight screw elements as claimed in claim 1.

16. The pair of four-flight screw elements as claimed in claim 1, wherein m is an integer chosen from the group consisting of 2, 3, 4, 6, 8, 10, 12 and 16.

17. The pair of four-flight screw elements as claimed in claim 8, wherein r(K2) is less than or equal to r(K1)−0.005*a and r(K2) is greater than or equal to r(K1)−0.04*a.

18. The pair of four-flight screw elements as claimed in claim 9, wherein r(K4) is less than or equal to r(K1)−0.005*a and r(K4) is greater than or equal to r(K1)−0.04*a.

19. The pair of four-flight screw elements as claimed in claim 10, wherein the crest angle KW1 is from greater than 2 degrees to less than 6 degrees.
